(19) United States
(12) Patent Application Publication
(10) Pub. No.: US 2024/0422721 A1
(43) Pub. Date: Dec. 19, 2024

(54) RTT Based Sidelink Ranging And Positioning

(71) Applicant: Huawei Technologies Co., Ltd., Shenzhen (CN)

(72) Inventors: Guosen Yue, Edison, NJ (US); Brian Classon, St. Pete Beach, FL (US); George Calcev, Hoffman Estates, IL (US); Vipul Desai, Palatine, IL (US)

(21) Appl. No.: 18/816,146

(22) Filed: Aug. 27, 2024

Related U.S. Application Data
(63) Continuation of application No. PCT/US2023/020456, filed on Apr. 28, 2023.
(60) Provisional application No. 63/336,124, filed on Apr. 28, 2022.

(51) Int. Cl. H04W 64/00; H04L 1/1829; H04W 92/18

(52) U.S. Cl. CPC H04W 64/00; H04L 1/1861; H04W 92/18

(57) ABSTRACT

A method implemented by first user equipment (UE) include transmitting a first sidelink position reference signal (SL Pos-RS) to a second UE at a first time (t1), receiving a second SL Pos-RS from the second UE at a fourth time (t4), receiving a timing measurement report from the second UE, wherein the timing measurement report contains information regarding a second time (t2) when the first SL Pos-RS was received by the second UE and regarding a third time (t3) when the second UE transmitted the second SL Pos-RS to the first UE, and calculating a distance between the first UE and the second UE based on the first time, the fourth time, and the timing measurement report.

### CROSS-REFERENCE TO RELATED APPLICATIONS

This is a continuation of International Application No. PCT/US2023/020456 filed on Apr. 28, 2023, which claims the benefit of U.S. Provisional Patent Application No. 63/336,124, filed Apr. 28, 2022, each of which is hereby incorporated by reference.

### TECHNICAL FIELD

The present disclosure relates generally to telecommunications and, in particular, to round trip time (RTT) based sidelink (SL) ranging and positioning.

### BACKGROUND

Sidelink (SL) communication is a communication scheme in which a direct link is established between User Equipments (UEs) and the UEs exchange voice and data directly with each other without intervention of a gnodeB (gNB). SL communication is under consideration as a solution to the overhead of the gNB caused by rapidly increasing data traffic.

The third-generation partnership project (3GPP) has been developing and standardizing several important features with fifth generation (5G) new radio access technology (NR). In Release-16, a work item for NR vehicle-to-everything (V2X) wireless communication with the goal of providing 5G-compatible high-speed reliable connectivity for vehicular communications was completed. This work item provided the basics of NR sidelink communication for applications such as safety systems and autonomous driving. In Release-16, a work item for NR positioning support was completed. In Release-18, a study item on expanded and improved NR positioning was approved which includes the study of sidelink positioning solutions. It is desirable to provide techniques and signaling to enable sidelink positioning.

### SUMMARY

In one aspect, the disclosure includes a method implemented by first user equipment (UE), comprising: transmitting a first sidelink position reference signal (SL Pos-RS) to a second UE at a first time (t₁); receiving a second SL Pos-RS from the second UE at a fourth time (t₄); receiving a timing measurement report from the second UE, wherein the timing measurement report contains information regarding a second time (t₂) when the first SL Pos-RS was received by the second UE and regarding a third time (t₃) when the second UE transmitted the second SL Pos-RS to the first UE; and calculating a distance between the first UE and the second UE based on the first time, the fourth time, and the timing measurement report.

Optionally, in any of the preceding aspects, another implementation of the aspect provides that the distance is calculated using the following formula:

$${D}_{1 , 2} = c \cdot \frac{( {t}_{4} - {t}_{1} ) - ( {t}_{3} - {t}_{2} )}{2} ,$$

where D_{1,2} represents the distance and where c represents the speed of light.

Optionally, in any of the preceding aspects, another implementation of the aspect provides that the first UE comprises a target UE, the second UE comprises an anchor UE, and wherein the timing measurement report includes a time value that represents a delta between the third time and the second time.

Optionally, in any of the preceding aspects, another implementation of the aspect provides that the first UE transmits two or more first SL Pos-RS in accordance to a first semi-persistent configuration, where the first semi-persistent configuration comprises a period, a number of first SL Pos-RS transmissions, and parameters to generate the two or more first SL Pos-RS; and that the first UE receives two or more second SL Pos-RS in accordance to a second semi-persistent configuration, where the second semi-persistent configuration comprises a period, a number of second SL Pos-RS transmissions, and parameters to generate the two or more second SL Pos-RS.

Optionally, in any of the preceding aspects, another implementation of the aspect provides the timing measurement report includes a value for each of the second time and the third time.

Optionally, in any of the preceding aspects, another implementation of the aspect provides the timing measurement report includes a value representing a difference between the second time and the third time, and wherein the difference represents fractions of a subframe or slot.

Optionally, in any of the preceding aspects, another implementation of the aspect provides the first time, the second time, the third time, and the fourth time each correspond to a reference orthogonal frequency-division multiplexing (OFDM) symbol.

Optionally, in any of the preceding aspects, another implementation of the aspect provides the timing measurement report includes a number of orthogonal frequency-division multiplexing (OFDM) symbols and a relative timing offset corresponding to the second time and the third time.

Optionally, in any of the preceding aspects, another implementation of the aspect provides the timing measurement report is contained within the second SL Pos-RS.

In one aspect, the disclosure includes a method implemented by first user equipment (UE), comprising: transmitting a first sidelink position reference signal (SL Pos-RS) to a second UE at a first time (t₁); receiving a physical sidelink feedback channel (PSFCH) sequence transmitted from the second UE on a PSFCH channel at a fourth time (t₄); receiving a timing measurement report from the second UE, wherein the timing measurement report contains information regarding a difference between a second time (t₂) when the first SL Pos-RS was received by the second UE and regarding a third time (t₃) when the second UE transmitted the second SL Pos-RS to the first UE; and calculating a distance between the first UE and the second UE based on the first time, the fourth time, and the timing measurement report.

Optionally, in any of the preceding aspects, another implementation of the aspect provides that the PSFCH sequence includes a plurality of PSFCHs in a single physical resource block (PRB) set.

Optionally, in any of the preceding aspects, another implementation of the aspect provides that a hybrid automatic repeat request acknowledgement (HARQ-ACK) is excluded from the single PRB set.

Optionally, in any of the preceding aspects, another implementation of the aspect provides that a hybrid automatic repeat request acknowledgement (HARQ-ACK) is included in the single PRB set and used for calculating the distance.

Optionally, in any of the preceding aspects, another implementation of the aspect provides that a cyclic shift is applied to the HARQ-ACK to shift the HARQ-ACK from the PSFCH channel to a different PSFCH channel.

Optionally, in any of the preceding aspects, another implementation of the aspect provides that physical resource block (PRB) sets not configured for the HARQ-ACK are used in the PSFCH sequence.

In one aspect, the disclosure includes a method implemented by a target user equipment (UE), comprising: selecting one or more anchor UEs for positioning; transmitting a positioning request to the one or more anchor UEs that were selected; receiving an acknowledgement from the one or more anchor UEs in response to the positioning request; transmitting a first sidelink position reference signal (SL Pos-RS) to the one or more anchor UEs from which the acknowledgement was received; receiving a second SL Pos-RS from each of the one or more anchor UEs from which the acknowledgement was received; receiving a timing measurement report from each of the one or more anchor UEs from which the acknowledgement was received; and calculating a distance between the target UE and the one or more UEs based on the timing measurement report received from the one or more anchor UEs.

Optionally, in any of the preceding aspects, another implementation of the aspect provides that the selecting further comprises identifying the one or more anchor UEs supporting multi-round trip time (RTT)-based positioning.

Optionally, in any of the preceding aspects, another implementation of the aspect provides discovering one or more available candidate anchor UEs and selecting the one or more UEs from the one or more available candidate anchor UEs.

Optionally, in any of the preceding aspects, another implementation of the aspect provides that the one or more anchor UEs are selected for positioning based on one or more of a source of synchronization, a received signal strength, an anchor feature, a location zone, and a mobility of the one or more anchor UEs.

Optionally, in any of the preceding aspects, another implementation of the aspect provides that the target UE receives the second SL Pos-RS from the one or more anchor UEs before transmitting the first SL Pos-RS to the one or more anchor UEs.

Optionally, in any of the preceding aspects, another implementation of the aspect provides that the timing measurement report is encoded in the second SL Pos-RS or multiplexed with the second SL Pos-RS.

In one aspect, the disclosure includes a method implemented by a target user equipment (UE), comprising: transmitting a positioning request to a first anchor UE and to a second anchor UE; receiving an acknowledgement from the first anchor UE and the second anchor UE in response to the positioning request; transmitting a first sidelink position reference signal (SL Pos-RS) of the target UE to the first anchor UE and the second anchor UE; receiving a second SL Pos-RS of the first anchor UE and a third SL Pos-RS of the second anchor UE in a slot; receiving a timing measurement report from at least one of the first anchor UE or the second anchor UE; and calculating a distance between the target UE and at least one of the first anchor UE or the second anchor UE based on the timing measurement report.

Optionally, in any of the preceding aspects, another implementation of the aspect provides that the second SL Pos-RS is interleaved with the third SL Pos-RS.

Optionally, in any of the preceding aspects, another implementation of the aspect provides that the second SL Pos-RS is disjoint from the third SL Pos-RS.

Optionally, in any of the preceding aspects, another implementation of the aspect provides that the second SL Pos-RS is separated from the third SL Pos-RS by one or more guard symbols.

Optionally, in any of the preceding aspects, another implementation of the aspect provides that a number of orthogonal frequency-division multiplexing (OFDM) symbols for each of the second SL Pos-RS and the third SL Pos-RS is four.

Optionally, in any of the preceding aspects, another implementation of the aspect provides that the timing measurement report is based on a measured receiver-transmitter (Rx-Tx) time difference, or is based on a Release-16 or Release-17 definition for gnodeB (gNB) Rx-Tx time difference measurement or UE Rx-Tx time difference in Uu.

Optionally, in any of the preceding aspects, another implementation of the aspect provides that the sidelink positioning measurement report is reported to a Location Management Function (LMF) and the UE determining a location.

Optionally, in any of the preceding aspects, another implementation of the aspect provides that for multi-round trip time (RTT)-based positioning, one or more transmissions of the first SL Pos-RS from the first UE and one or more transmissions of the second SL Pos-RS and the second UE are without order restriction between multiple rounds of SL Pos-RS transmissions.

Optionally, in any of the preceding aspects, another implementation of the aspect provides that a UE is configured to receive an SL PRS resource allocation signaling from a gNB through a dynamic grant to transmit a SL Pos-RS.

Optionally, in any of the preceding aspects, another implementation of the aspect provides that transmissions of comb-based SL Pos-RS are multiplexed from one or more UEs in a slot in a sidelink resource pool.

Optionally, in any of the preceding aspects, another implementation of the aspect provides that a configuration of a SL Pos-RS comprises a single (M, N) value for comb-based multiplexing in a slot of two or more SL Pos-RS from two or more UEs, and wherein M is number of OFDM symbols in the slot scheduled for the SL-Pos-RS and N is a comb size.

Optionally, in any of the preceding aspects, another implementation of the aspect provides that the comb size comprises 2 and 4.

Optionally, in any of the preceding aspects, another implementation of the aspect provides that the sidelink positioning measurement report compromises a measurement including a line-of-sight (LOS) path or all non-line-of-sight (NLOS) paths.

Optionally, in any of the preceding aspects, another implementation of the aspect provides that the UE is configured to perform either a first resource allocation scheme or a second resource allocation scheme applicable to all resource pools, and wherein an SL PRS unicast, groupcast, or broadcast occurs in the resource pool.

Optionally, in any of the preceding aspects, another implementation of the aspect provides that a transmission of the SL Pos-RS is in response to a trigger, wherein the trigger is provided by higher layers of the UE or a lower signaling provided by a second UE, and wherein the lower layer signaling comprises sidelink control information (SCI) or sidelink media access control-control element (SL MAC-CE).

Optionally, in any of the preceding aspects, another implementation of the aspect provides that a configuration of the SL PRS comprises: SL PRS resource identifier (ID), SL PRS comb offset and associated SL-PRS comb size (N), SL PRS starting symbol and number of SL-PRS symbols (M), and SL PRS frequency domain allocation.

Optionally, in any of the preceding aspects, another implementation of the aspect provides that anchor UE location information is provided to the LMF or the UE for provision of assistance information for absolute SL positioning.

Optionally, in any of the preceding aspects, another implementation of the aspect provides that the UE receives a physical sidelink control channel (PSCCH) and the SL Pos-RS time division multiplexed in a same slot.

Optionally, in any of the preceding aspects, another implementation of the aspect provides that the transmission of a SL Pos RS in a resource pool is in response to a Release 16 resource selection or reselection procedure with periodic and without periodic reservations.

In one aspect, the disclosure includes a user equipment (UE), comprising: one or more processors; a transmitter coupled to the one or more processors; and a receiver coupled to the one or more processors, wherein the one or more processors, the transmitter, and the receiver are configured to perform any of the disclosed methods.

In one aspect, the disclosure includes a non-transitory computer readable medium comprising a computer program product for use by a user equipment (UE), the computer program product comprising computer executable instructions stored on the non-transitory computer readable medium such that when executed by one or more processors cause the UE to perform any of the disclosed methods.

In one aspect, the disclosure includes a target User Equipment (UE), comprising: a transmitting means for transmitting a positioning request directly to one or more anchor UEs via a sidelink communication; a receiving means for receiving positioning data from the anchor UEs via the sidelink communication; and a calculation means for calculating range or positioning measurements based on the positioning data.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram illustrating in-coverage/out-of-coverage operation.

FIG. 2 is an illustration of a resource pool in a resource grid.

FIG. 3 is an illustration of a resource grid with a physical sidelink control channel (PSCCH), a physical sidelink shared channel (PSCCH), and a physical sidelink feedback channel (PSCCH).

FIG. 4 is an illustration of a structure of a Sidelink Synchronization Signal Block (S-SSB).

FIG. 5 is an illustration of an uplink (UL) sounding reference signal (SRS).

FIG. 6 is an illustration of an example of a downlink positioning reference signal (PRS).

FIG. 7 is an illustration of sensing and resource selection windows from Release 16 (Rel-16) new radio (NR) vehicle-to-everything (V2X).

FIG. 8 is an illustration of a round trip time (RTT)-based ranging in sidelink.

FIG. 9 is an illustration of multi-RTT positioning in sidelink.

FIG. 10 is a flowchart for SL ranging.

FIG. 11 is an illustration of sidelink position reference signal (SL Pos-RS) transmissions in SL ranging.

FIG. 12 is an illustration of message flow in RTT-based SL ranging.

FIG. 13 is an illustration of RTT timing in SL ranging and positioning.

FIG. 14 is an illustration of Physical sidelink shared channel (PSSCH) and physical sidelink feedback channel (PSFCH) hybrid automatic repeat request acknowledgement (HARQ-ACK) mapping.

FIG. 15 is an illustration of PSFCH channels in PSFCH HARQ-ARK physical resource block (PRB) sets for RTT-based SL positioning.

FIG. 16 is an illustration of additional PRB sets for responding to Pos-RS in RTT-based SL positioning.

FIG. 17 is a flowchart for SL multi-RTT-based positioning.

FIG. 18 is an illustration of two UL SRS (as SL PRS) transmissions on a same slot in sidelink.

FIG. 19 is an illustration of a network for communicating data.

FIG. 20 is an illustration of a processing system.

FIG. 21 is an illustration of a transceiver adapted to transmit and receive signaling over a telecommunications network.

FIG. 22 is an illustration of an effect of an angle of arrival (AOA) and angle of departure (AOD) on non-line-of-side (NLOS) propagation.

FIG. 23 is an illustration of a resource slot offset.

FIG. 24 is an illustration of a UL PRS resource configuration.

FIG. 25 is an illustration of a S-SSB.

FIG. 26 is a method implemented by a first UE according to an embodiment of the present disclosure.

FIG. 27 is a method implemented by a first UE according to an embodiment of the present disclosure.

FIG. 28 is a method implemented by a target UE according to an embodiment of the present disclosure.

FIG. 29 is a method implemented by a target UE according to an embodiment of the present disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The 3^{rd} Generation Partnership Project (3GPP) uses a system of parallel “Releases” that provide developers with a stable platform for the implementation of features at a given point and then allow for the addition of new functionality in subsequent Releases. The 3^{rd} Generation Partnership Project (3GPP) Release 18 (Rel.18) recently set the initial phase towards 5G Advanced as the mid-point of 5G standardization. In that regard, the 3GPP has already announced its decision to recognize Rel.18 as the first release of 5G Advanced.

One issue with 5G networks is congestion and overhead experienced at the BS (e.g., a gNB). Sidelink (SL) communication is a communication scheme in which a direct link is established between UEs so that the UEs are able to exchange voice and data directly with each other without intervention of the gNB. SL communication is under consideration as a solution to the overhead issues of the gNB caused by rapidly increasing data traffic.

The 3GPP technical specification group (TSG) Radio Access Network (RAN) is responsible for the technical co-ordination of the specification work done in the following Working Groups: RAN1—Radio Layer 1 (Physical layer), and RAN2—Radio layer 2 and Radio layer 3 Radio Resource Control. As part of Rel.18, a positioning study item description (SID) was established for RAN1 and RAN2 with the objective of studying and evaluating the performance and feasibility of potential solutions for SL positioning considering relative positioning, ranging, and absolute positioning. In particular, the RAN1 working group was tasked with studying positioning methods (e.g., time difference of arrival (TDOA), round trip time (RTT), angle of arrival (AOA), angle of departure (AOD), etc.) including the combination of SL positioning measurements with other radio access technology (RAT)-dependent positioning measurements (e.g., Uu-based measurements). The RAN1 working group was also tasked with studying sidelink reference signals for positioning purposes from a physical layer perspective, including signal design resource allocation, measurements, associated procedures, and so on, as well as reusing existing reference signals, procedures, and so on, from sidelink communication and from positioning as much as possible.

Unfortunately, no solution exists to implement sidelink positioning in a 5G NR network as described in the Rel.18 enhancement work item description (WID). That is, SL communication is not yet compatible with the 5G Advanced standard.

Disclosed herein are techniques to implement SL communication in a 5G Advanced network. In particular, these techniques cover RTT-based SL ranging and multi-RTT-based SL positioning. By making SL communication compatible with the 5G Advanced standard, UEs are able to communicate directly with one another without the gNB overhead. Thus, communication between UEs is improved. The disclosed embodiments also improve the ranging accuracy of UEs and performance of UE positioning. For high mobility UEs, the distance change can be captured with multiple measurements and the estimation of the latest distance can also be improved.

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

### INTRODUCTION

The third-generation partnership project (3GPP) has been developing and standardizing several important features with fifth generation (5G) new radio access technology (NR). In Release-16, a work item for NR vehicle-to-everything (V2X) wireless communication with the goal of providing 5G-compatible high-speed reliable connectivity for vehicular communications was completed. This work item provided the basics of NR sidelink communication for applications such as safety systems and autonomous driving. High data rates, low latencies, and high reliabilities were some of the key areas investigated and standardized. In Release-17, a work item Sidelink Enhancement was completed to further enhance the capabilities and performance of sidelink communication. One of the important objectives of the work item was to introduce an inter-UE coordination mechanism where one UE shares preferred or non-preferred resources for another UE to use in its resource selection or sends a conflict indication to another UE when there is a conflict on its reserved resources.

In Release-16, a work item for NR positioning support was completed, which provides positioning support in 5G NR including downlink (DL) and uplink (UL) reference signals for various positioning techniques (DL-time difference of arrival (TDOA), DL-AOD, UL-TDOA, UL-AOA, multi-cell RTT, and E-CID), as well as the UE and gnodeB (gNB) measurements for NR positioning. In Release-17, a work item for NR Positioning Enhancements with the goal of supporting high accuracy, low latency, network efficiency, and device efficiency requirements for commercial uses cases was completed. This work item provided methods, measurements, signaling, and procedures for improving positioning accuracy over Release-16 positioning methods.

In Release-18, a study item on expanded and improved NR positioning was approved which includes the study of sidelink positioning solutions.

In the present disclosure, techniques and signaling to enable sidelink positioning are described.

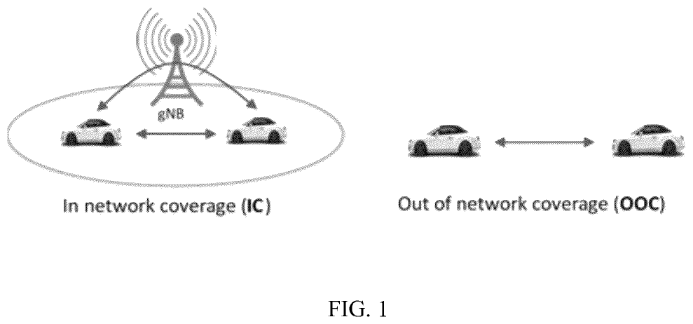

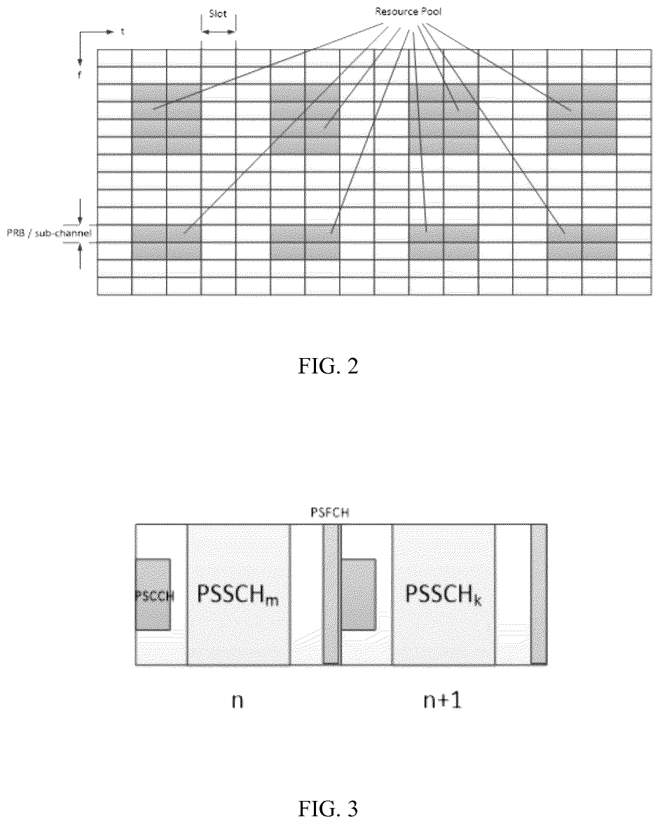

FIG. 1 is a diagram illustrating in-coverage/out-of-coverage operation. Sidelink communication can either be in-coverage, or out-of-coverage: with in-coverage (IC) operation, a central node (e.g., gNB) is present and can be used to manage the sidelink (mode 1). In mode 2 operation, system operation is fully distributed, and UEs select resources on their own. In the present disclosure, some UEs can also be facilitated/assisted in selecting their resources. Note in mode 2, UEs can be either in-coverage or out-of-coverage (OOC).

For the purposes of sidelink communications, the notion of resource pools was introduced for LTE sidelink and is being reused for NR sidelink. A resource pool is a set of resources that can be used for sidelink communication. Resources in a resource pool are configured for different channels including control channels, shared channels, feedback channels, synchronization signals, reference signals, broadcast channels (e.g., master information block), and so on. The 3GPP standard (Technical Specification (TS) 38.331) defines rules on how the resources are shared and used for a particular configuration of the resource pool.

A resource pool for sidelink can be configured in units of slots in the time domain and physical resource blocks (PRBs) or sub-channels in the frequency domain. A sub-channel consists of one or more PRBs. FIG. 3 is an example of a resource grid with a physical sidelink control channel (PSCCH), a physical sidelink shared channel (PSCCH), and a physical sidelink feedback channel (PSCCH).

For NR mobile broadband (MBB), each physical resource block (PRB) in the grid is defined as a slot of 14 consecutive orthogonal frequency-division multiplexing (OFDM) symbols in the time domain and 12 consecutive subcarriers in the frequency domain, i.e., each resource block contains 12×14 resource elements (REs). When used as a frequency-domain unit, a PRB is 12 consecutive subcarriers. There are 14 symbols in a slot when a normal cyclic prefix (CP) is used and 12 symbols in a slot when an extended cyclic prefix (ECP) is used. The duration of a symbol is inversely proportional to the subcarrier spacing (SCS). For a {15, 30, 60, 120} kilohertz (kHz) SCS, the duration of a slot is {1, 0.5, 0.25, 0.125} milliseconds (ms), respectively. Each PRB may be allocated to combinations of a control channel (CCH), a shared channel (SCH), a feedback channel, reference signals (RS), and so on. In addition, some REs of a PRB may be reserved. A similar structure is used on the sidelink as well. A communication resource may occupy a PRB, a set of PRBs, and use a code (if code-division multiple access (CDMA) is used, similarly as for the PUCCH), a physical sequence, a set of REs, and so on.

The physical sidelink control channel (PSCCH) carries sidelink control information (SCI). The source UE uses the SCI to schedule the transmission of data on the physical sidelink shared channel (PSSCH). The SCI can convey the time and frequency resources of the PSSCH, parameters for hybrid automatic repeat request (HARQ) process, such as the redundancy version, process identifier (id), new data indicator, and resources for the physical sidelink feedback channel (PFSCH). The PFSCH can carry an indication (HARQ-ACK) of whether the recipient [destination] UE decoded the payload carried on PSSCH correctly (e.g., an acknowledgement or negative acknowledgement (ACK/NACK)). The SCI can also carry a bit field indicating a representation of the identity of the source UE. In addition, the SCI can also carry a bit field indicating a representation of the identity of the destination UE(s). Other fields include the modulation coding scheme (MCS) used to encode the payload and modulate the coded payload bits; the demodulation reference signal (DMRS) pattern, the antenna ports, and priority of the payload (transmission).

The NR sidelink control information (SCI), can be transmitted in two stages. A first stage (shown below) can use SCI Format 1-A and a second stage can use SCI Formats 2-A, B or C. The first stage indicates the resources for the second stage SCI.

SCI format 1-A (from TS 38.212).

SCI format 1-A is used for the scheduling of PSSCH and 2nd-stage-SCI on PSSCH.

The following information is transmitted by means of the SCI format 1-A:
Priority-3 bits as defined in clause 5.4.3.3 of [12, TS 23.287].
Frequency resource assignment —

$$⌈ {log}_{2} ( \frac{{N}_{subChannel}^{SL} ( {N}_{subChannel}^{SL} + 1 )}{2} ) ⌉$$

bits when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChanne1}^{SL} + 1 )}{6} ) ⌉$$

bits when the value of the higher layer parameter sl-MaxNumPerReserve is configured to 3, as defined in clause 8.1.2.2 of [6, TS 38.214].
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.2.1 of [6, TS 38.214].
Resource reservation period—┌log₂ N_{rsv_period}┐ bits as defined in clause 8.1.4 of [6, TS 38.214], where N_{rsv_period} is the number of entries in the higher layer parameter sl-ResourceReservePeriodList, if higher layer parameter sl-MultiReserveResource is configured; 0 bit otherwise.
DMRS pattern—┌log₂ Nₚₐₜₜₑᵣₙ┐ bits as defined in clause 8.4.1.1.2 of [4, TS 38.211], where Nₚₐₜₜₑᵣₙ is the number of DMRS patterns configured by higher layer parameter sl-PSSCH-DMRS-TimePatternList; 0 bit if sl-PSSCH-DMRS-TimePatternList is not configured.
2nd-stage SCI format—2 bits as defined in Table 8.3.1.1-1.
Beta_offset indicator—2 bits as provided by higher layer parameter sl-BetaOffsets2ndSCI and Table 8.3.1.1-2.
Number of DMRS port—1 bit as defined in Table 8.3.1.1-3.
Modulation and coding scheme—5 bits as defined in clause 8.1.3 of [6, TS 38.214].
Additional MCS table indicator—as defined in clause 8.1.3.1 of [6, TS 38.214]: 1 bit if one MCS table is configured by higher layer parameter sl-Additional-MCS-Table; 2 bits if two MCS tables are configured by higher layer parameter sl-Additional-MCS-Table; 0 bit otherwise.
PSFCH overhead indication—1 bit as defined clause 8.1.3.2 of [6, TS 38.214] if higher layer parameter sl-PSFCH-Period=2 or 4; 0 bit otherwise.
Reserved—a number of bits as determined by higher layer parameter sl-NumReservedBits, with value set to zero.

SCI format 2-A (from TS38.212).

SCI format 2-A is used for the decoding of PSSCH, with HARQ operation when HARQ-ACK information includes ACK or NACK, or when there is no feedback of HARQ-ACK information.

The following information is transmitted by means of the SCI format 2-A:
HARQ process number—┌log₂ N_{process}┐ bits as defined in clause 16.4 of [5, TS 38.213].
New data indicator—1 bit as defined in clause 16.4 of [5, TS 38.213].
Redundancy version—2 bits as defined in clause 16.4 of [6, TS 38.214].
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Cast type indicator—2 bits as defined in Table 8.4.1.1-1.
Channel state information (CSI) request—1 bit as defined in clause 8.2.1 of [6, TS 38.214].

TABLE 8.4.1.1-1
Cast type indicator

| Value of Cast type | |
|---|---|
| indicator | Cast type |
| 00 | Broadcast |
| 01 | Groupcast |
| 10 | Unicast |
| 11 | Reserved |

SCI format 2-B (From TS38.212).

SCI format 2-B is used for the decoding of PSSCH, with HARQ operation when HARQ-ACK information includes only NACK, or when there is no feedback of HARQ-ACK information.

The following information is transmitted by means of the SCI format 2-B:
HARQ process number—┌log₂ N_{process}┐ bits as defined in clause 16.4 of [5, TS 38.213].
New data indicator—1 bit as defined in clause 16.4 of [5, TS 38.213].
Redundancy version—2 bits as defined in clause 16.4 of [6, TS 38.214].
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Zone ID—12 bits as defined in clause 5.8.1.1 of [9, TS 38.331].
Communication range requirement—4 bits as defined in [9, TS 38.331]

SCI format 2-C(From TS38.212).

SCI format 2-C is used for the decoding of PSSCH, and providing inter-UE coordination information or requesting inter-UE coordination information.

The following information is transmitted by means of the SCI format 2-C:
HARQ process number—4 bits
New data indicator—1 bit
Redundancy version—2 bits as defined in Table 7.3.1.1.1-2
Source ID—8 bits as defined in clause 8.1 of [6, TS 38.214]
Destination ID—16 bits as defined in clause 8.1 of [6, TS 38.214]
HARQ feedback enabled/disabled indicator—1 bit as defined in clause 16.3 of [5, TS 38.213]
CSI request—1 bit as defined in clause 8.2.1 of [6, TS 38.214] and in clause 8.1 of [6, TS 38.214]
Providing/Requesting indicator—1 bit, where value 0 indicates SCI format 2-C is used for providing inter-UE coordination information and value 1 indicates SCI format 2-C is used for requesting inter-UE coordination information

If the ‘Providing/Requesting indicator’ field is set to 0, all the remaining fields are set as follows:
Resource combinations—

$$2 \cdot ( ⌈ {log}_{2} ( \frac{{N}_{subChannel}^{SL} ( {N}_{subChannel}^{SL} + 1 ) ( 2 {N}_{subChannel}^{S L} + 1 )}{6} ) ⌉ + 9 + Y )$$

bits as defined in Clause 8.1.5A of [6, TS 38.214], where
Y=┌log₂ N_{rsv_period}┐ and N_{rsv_period} is the number of entries in the higher layer parameter sl-ResourceReservePeriodList, if higher layer parameter sl-MultiReserveResource is configured; Y=0 otherwise
N_{subChannel}^{SL} is the number of subchannels in a resource pool provided by the higher layer parameter sl-NumSubchannel
First resource location—8 bits as defined in Clause 8.1.5A of [6, TS 38.214].
Reference slot location—(10+┌log₂(10·2^{μ})┐) bits as defined in Clause 8.1.5A of [6, TS 38.214], where μ is defined in Table 4.2-1 of Clause 4.2 of [4, TS 38.211].
Resource set type—1 bit, where value 0 indicates preferred resource set and value 1 indicates non-preferred resource set.
Lowest subChannel indices—2·┌log₂ N_{subChannel}^{SL}┐ bits as defined in Clause 8.1.5A of [6, TS 38.214].

If the ‘Providing/Requesting indicator’ field is set to 1, all the remaining fields are set as follows:
Priority—3 bits as specified in clause 5.4.3.3 of [12, TS 23.287] and clause 5.22.1.3.1 of [8, TS 38.321]. Value ‘000’ of Priority field corresponds to priority value ‘1’, value ‘001’ of Priority field corresponds to priority value ‘2’, and so on.
Number of subchannels—┌log₂ N_{subChannel}^{SL}┐ bits as defined in Clause 8.1.4A of [6, TS 38.214].
Resource reservation period—┌log₂ N_{rsv_period}┐ bits as defined in Clause 8.1.4A of [6, TS 38.214], where N_{rsv_period} is the number of entries in the higher layer parameter sl-ResourceReservePeriodList, if higher layer parameter sl-MultiReserveResource is configured; 0 bit otherwise.
Resource selection window location—2·(10+┌log₂ (10·2^{μ})┐) bits as defined in Clause 8.1.4A of [6, TS 38.214], where μ is defined in Table 4.2-1 of Clause 4.2 of [4, TS 38.211].
Resource set type—1 bit, where value 0 indicates a request for inter-UE coordination information providing preferred resource set and value 1 indicates a request for inter-UE coordination information providing non-preferred resource set, if higher layer parameter determineResourceSetTypeSchemel is configured to ‘UE-B's request’; otherwise, 0 bit.
Padding bits.

Higher Layer Messages (from TS38.331).

| SL-PSCCH-Config-r16 ::= | SEQUENCE { | |
|---|---|---|
| sl-TimeResourcePSCCH-r16 | ENUMERATED {n2, n3} OPTIONAL, -- Need M | |
| sl-FreqResourcePSCCH-r16 | ENUMERATED {n10,n12, n15, n20, n25} OPTIONAL, -- Need M | |
| sl-DMRS-ScrambleID-r16 | INTEGER (0..65535) | OPTIONAL, -- Need M |
| sl-NumReservedBits-r16 | INTEGER (2..4) | OPTIONAL, -- Need M |
| ... | | |
| } | | |

SL-PSCCH field descriptions
sl-FreqResourcePSCCH
Indicates the number of PRBs for PSCCH in a
resource pool where it is not greater than the
number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

Sidelink Inter-UE Coordination.

In Rel-17, sidelink inter-UE coordination (IUC) is specified to improve mode 2 reliability by overcoming the issues such as hidden-node, exposed-node, and half-duplex, that impact sidelink performance. In particular, two IUC schemes were defined, i.e.,

Scheme 1: inter-UE coordination information signalling from UE-A to UE-B
Set of resources preferred for UE-B's transmission
Set of resources non-preferred for UE-B's transmission

Scheme 2: inter-UE coordination information signalling from UE-A to UE-B
Presence of expected/potential resource conflict on the resources indicated by UE-B's SCI

In IUC Scheme 1, two IUC triggering scenarios were considered and specified, i.e., 1) Coordination triggered by an explicit request where UE-B sends explicit request to UE-A and UE-A, upon request, generates and sends the coordination information (preferred resource set or non-preferred resource set to UE-B; 2) Coordination triggered by a condition other than an explicit request where a UE (UE-A) that satisfies certain condition(s) generates and sends coordination information to UE-B.

The conditions for the two IUC triggering scenarios were also specified. For IUC triggered by an explicit request, one of the two conditions is configured for the resource pool level, i.e., alt 1—up to UE-B's implementation and alt 2—the request can be triggered only when UE-B has data to be transmitted to UE-A. Similarly, for IUC triggered by a condition, two conditions were agreed with one of them enabled by resource pool level (pre-)configuration, i.e., alt 1—up to UE-A's implementation, and alt 2—the coordination can be triggered only when UE-A has data to be transmitted together with coordination information to UE-B.

The criteria for generating the coordination information, i.e., preferred resource set and non-preferred resource set are defined as follows.
Preferred resource set:
   Condition 1-A-1: Resource(s) excluding the overlapped reserved resource(s) of other UE with Reference Signal Received Power (RSRP) larger than a threshold
   Condition 1-A-2: Resource(s) excluding the slots when UE-A, as receiver (Rx) of UE-B, does not expect to perform SL reception from UE-B
Non-preferred resource set:
   Condition 1-B-1: Reserved resource(s) of other UE identified by and RSRP measurement
      Option 1: Reserved resource(s) of other UE(s) identified by UE-A whose RSRP measurement is larger than a (pre-)configured RSRP threshold
      Option 2: Reserved resource(s) of other UE identified by UE-A whose RSRP measurement is smaller than a (pre-)configured RSRP threshold when UE-A is a destination of a TB transmitted by the UE(s)
   Condition 1-B-2: Resource(s) (e.g., slot(s)) where UE-A, when it is intended receiver of UE-B, does not expect to perform SL reception from UE-B

To send explicit request and coordination information, a media access control-control element (MAC-CE) is used as the container. If configured, the 2nd stage SCI, SCI format 2C, is also used for explicit request or coordination information.

For coordination triggered by an explicit request, only unicast is supported for both transmissions of explicit request and coordination information. For coordination triggered by a condition, unicast is supported for transmission of both types of coordination information. Broadcast and groupcast are supported for non-preferred resource set only.

The coordination information and explicit request can be transmitted multiplexed with data only when the source/destination identifier (ID) pair is the same.

Sidelink Synchronization Signal Block (S-SSB).

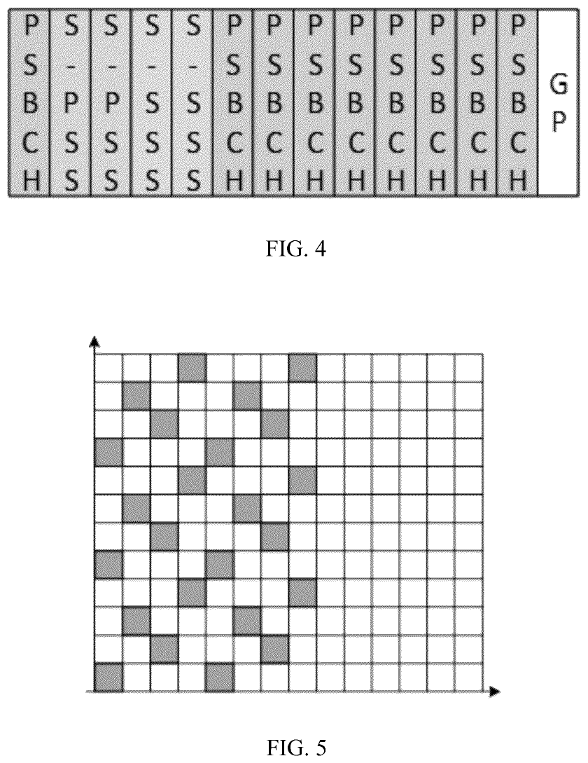

A synchronization slot in sidelink, i.e., Sidelink Synchronization Signal Block (S-SSB) is specified for one UE to synchronize with another UE. As shown in FIG. 4, the first OFDM symbol is for physical sidelink broadcast channel (PSBCH). But like the regular sidelink slot, the first symbol is for the settling of the automatic control gain (AGC). After which, there are two symbols for Sidelink Primary Synchronization Signals (S-PSS) and two for the Sidelink Secondary Synchronization Signals (S-SSS). Eight of the remaining nine symbols are for PSBCH transmission. The last symbol is a guard period (GP), same as in the regular sidelink slot.

In the frequency domain, the S-SSB occupies 11 PRBs with total 132 subcarriers. PSBCH occupies all 11 PRBs while the size of synchronization signal is 127; thus, Sidelink Primary Synchronization Signals (S-PSS) and Sidelink Secondary Synchronization Signals (S-SSS) occupy 127 subcarriers.

The periodicity of S-SSB is 160 ms. The frequency location of the S-SSB is pre-configured. The number of S-SSB transmissions is set to 1 for frequency range 1 (FR1) and is configurable for frequency range 2 (FR2).

Sounding Reference Signal (SRS).

In NR, as specified in 38.211, an SRS resource with 1, 2, or 4 antenna ports is supported which can be mapped to N_{symb}^{SRS}∈{1,2,4,8,12} consecutive OFDM symbols. Transmission comb (kTC) on every 2 or 4 or 8 REs in the frequency domain is supported. In addition, cyclic shift is supported with the maximum number of cyclic shifts, n_{SRS}^{cs,max}, equal to 8, 12, and 6 when size of comb is 2, 4, and 8, respectively. The SRS sequence ID is configured by higher layer parameters. The starting OFDM symbol l₀ in the time domain is defined by an offset l_{offset} from the end of the slot, where l_{offset}∈{0,1, . . . , 13} indicating the starting position can be any OFDM symbol in the slot. The frequency starting position is also specified. For positioning, an additional offset in frequency domain k_{offset}^{l′} was specified which is also dependent of the OFDM symbol configured for SRS transmissions. An SRS resource may be configured for periodic, semi-persistent, aperiodic SRS transmission. In the frequency domain, SRS allocation is aligned with the 4 PRB grid. Frequency hopping is supported as in the case of long-term evolution (LTE). With same design approach, NR SRS bandwidth and hopping configuration are designed to cover a larger span of values compared to that of LTE.

As specified in 38.211, an SRS resource is configured by the SRS-Resource information element (IE) for UL channel sounding or the SRS-Pos Resource IE for positioning purposes. FIG. 5 illustrates a UL SRS with comb size K_{TC}=4 on N_{symb}^{SRS}=8 OFDM symbols in a slot.

The UE can be configured with one or more SRS resource sets. For each SRS resource set, a UE may be configured with a number of SRS resources. The use case (such as beam management, codebook-based uplink multiple-input and multiple-output (MIMO), and non-codebook-based uplink MIMO, and antenna switching which actually is for general downlink CSI acquisition) for an SRS resource set is configured by the higher layer parameter.

In the time domain at slot level, an SRS resource can be configured periodically with a periodicity T_{SRS} (in slots) and slot offset T_{Offset}.

TABLE 6.4.1.4.2-1
Maximum number of cyclic shifts n_{SRS}^{cs,max}
as a function of K_{TC}. (TS 38.211)

| KTC | n_{SRS}^{cs,max} |
|---|---|
| 2 | 8 |
| 4 | 12 |
| 8 | 6 |

TABLE 6.4.1.4.3-2
The offset k_{offset}^{l′} for SRS as a function of K_{TC} and l′.

| | k_{offset}⁰ , . . . , k_{offset}^{N}^{_{symb}}^{^{SRS}}⁻¹ | | | | |
|---|---|---|---|---|---|
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

### Positioning Reference Signal (PRS)

Positioning reference signal (PRS) is the downlink reference signal for positioning purpose. PRS is also called DL-PRS while the UL SRS configured for positioning is sometimes called UL-PRS.

DL-PRS is specified with a starting symbol lₛₜₐᵣₜ^{PRS}∈{0, . . . ,12}, the size (number of OFDM symbols) of PRS L_{PRS}∈{2,4,6,12}, the frequency domain interval of two DL-PRS resource-elements (i.e., the comb size) K_{comb}^{PRS}∈{2,4,6,12} which is selected from a specified, subset of {L_{PRS}, K_{comb}^{PRS}} combinations, the initial frequency domain offset K_{offset}^{PRS}∈{0,1, . . . , K_{comb}^{PRS}−1}, and, similarly as the UL-SRS for positioning, an additional frequency domain offset k′ specified in a table (Table 7.4.1.7.3-1 of TS38.211) which varies over OFDM symbol to symbol.

TABLE 74.1.7.3-1
The frequency offset k′ as a function of l − lₛₜₐᵣₜ^{PRS}.

| | Symbol number within the downlink PRS | | | | | | | | | | | |
|---|---|---|---|---|---|---|---|---|---|---|---|---|
| | resource l − lₛₜₐᵣₜ^{PRS} | | | | | | | | | | | |
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

In the time domain at the slot level, DL-PRS can be configured with a periodicity Tₚₑᵣ^{PRS}∈2^{μ}{4, 5, 8, 10, 16, 20, 32, 40, 64, 80, 160, 320, 640, 1280, 2560, 5120, 10240} and a slot offset T_{offset}^{PRS}∈{0,1, . . . , Tₚₑᵣ^{PRS}−1}, as well as an additional slot offset T_{offset,res}^{PRS}. The bandwidth of the DL-PRS can be configured in a range from 24 to 275 PRBs with a step of 4 PRBs.

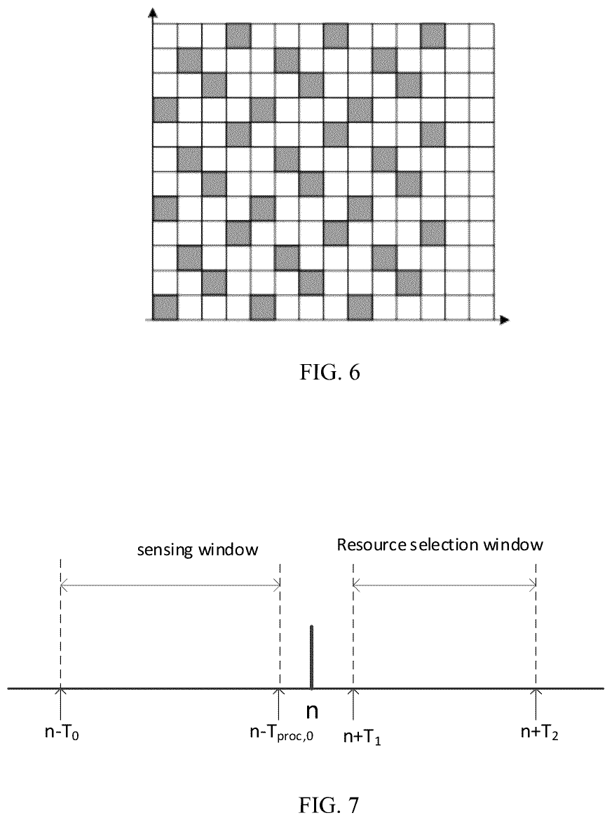

FIG. 6 is an example of DL PRS with comb size K_{comb}^{PRS}=4, lₛₜₐᵣₜ^{PRS}=0, and L_{PRS}=12 OFDM symbols in a slot.

SL Positioning in 3GPP Rel-18.

The need for 3GPP to develop sidelink positioning solutions has been discussed in the 3GPP Rel-18 planning phase. It has been shown that various important use cases can benefit from the SL positioning, such as the V2x and public safety use cases in Technical Report (TR) 38.845, ranging-based services in TS22.261, and industrial internet of things (IIoT) use cases (TS22.104).

At RANP #94, a Rel-18 study item on expanded and improved NR positioning (RP-213588) was agreed, which includes an objective of SL positioning as:
Study and evaluate performance and feasibility of potential solutions for SL positioning, considering relative positioning, ranging and absolute positioning: [RAN1, RAN2]
   Evaluate bandwidth requirement needed to meet the identified accuracy requirements [RAN1]
   Study of positioning methods (e.g. TDOA, RTT, AOA/D, etc.) including combination of SL positioning measurements with other RAT dependent positioning measurements (e.g. Uu based measurements) [RAN1]
   Study of sidelink reference signals for positioning purposes from physical layer perspective, including signal design, resource allocation, measurements, associated procedures, etc., reusing existing reference signals, procedures, etc., from sidelink communication and from positioning as much as possible [RAN1]
   Study of positioning architecture and signaling procedures (e.g. configuration, measurement reporting, etc.) to enable sidelink positioning covering both UE based and network based positioning [RAN2, including coordination and alignment with RAN3 and SA2 as required]

### BACKGROUND

### Sidelink Mode 1 Resource Allocation

In Rel-16 NR V2X sidelink mode 1, the gNB performs scheduling of the sidelink, i.e., gNB allocates the SL resources for SL communications, and the resource allocation is sent to the UE through the NR Uu interface. Therefore, sidelink mode 1 is applicable to UEs under the coverage of a gNB. The resources allocated with mode-1 can be either on the same carrier as cellular NR or a dedicated sidelink carrier.

There are three types of mode 1 resource allocations, i.e., dynamic assignment, type 1 configured grant (CG), and type 2 configured grant. In dynamic assignment, the UE first sends a scheduling request (SR) for every TB to the gNB via the PUCCH. Then gNB sends a SL resource allocation to the UE via DCI format 3_0 over the Physical Downlink Control Channel (PDCCH). In CG based resource allocation, UE first sends a message to the gNB with the expected SL traffic, e.g., periodicity, the TB maximum size, and QoS information. The gNB provides resource allocation, i.e., a CG to the UE the gNB provides by RRC signaling. In type 1 CG, the UE can use the resource allocation immediately. In type 2 CG, the UE uses the allocated resources after activated by gNB via a downlink control information (DCI).

### Sidelink Mode 2 Resource Allocation

In Rel-16 sidelink, mode 2 UEs transmit and receive information without the need of the network management. UEs themselves allocate the resources from a resource pool for sidelink transmissions. Resource allocation relies on a sensing and reservation process as shown in FIG. 7. During the sensing procedure, a monitoring UE detects SCI transmitted in each slot in the sensing window and measures RSRP of the resource indicated in the SCI. A monitoring UE may also receive transmissions of data (also be a receiving UE). For periodic traffic, the resource reservations for sidelink transmissions, if a UE occupies a resource on slot sₖ, it will also occupy the resource on slot SK+q*RRIₖ where q is an integer, RRIₖ is resource reservation interval for UE m that the sensing UE detected. Detecting the SCI includes the steps of receiving and decoding the PSCCH and processing the SCI within the PSCCH.

For aperiodic or dynamic transmissions, the transmitting UE reserves multiple resources and indicates the next resource in the SCI. Therefore, based on the sensing results, a monitoring UE can determine which resources may be occupied in the future and can avoid those resources for its own transmission if the measured RSRP on the occupied resource during the sensing period is above the RSRP threshold in the resource exclusion procedure as described in TS38.214.

FIG. 7 shows the timing information on the sensing and resource selection for Rel-16 NR sidelink transmission, which is usually referred as full sensing. When resource selection is triggered on slot n, based on sensing results in the sensing window, i.e., on slots [n-T₀, n-T_{proc,0}], the transmitting UE selects the resources in the resource selection window in a resource pool, i.e., on slots [n+T₁, n+T₂], where:
T₀: number of slots with the value determined by resource pool configuration;
T_{proc,o}: time required for a UE to complete the sensing process;
T₁: processing time required for identification of candidate resources and resource selection T₁≤T_{proc,1};
T₂: the last slot of resource pool for resource selection which is left to UE implementation but in the range of [T₂ₘᵢₙ, Packet Delay Budget (PDB)] where T₂ₘᵢₙ is minimum value of T₂ and PDB denotes packet delay budget, the remaining time for UE transmitting the data packet.
T_{proc,1}: maximum time required for a UE to identify candidate resources and select new sidelink resources;

### NR Positioning Methods

Several positioning methods have been agreed in NR (TS 38.305) which include DL-based solutions, UL-based solutions, and DL- and UL-based solutions.

### DL-Based Solutions

Timing based technique-Downlink Time Difference of Arrival (DL-TDOA): Similar to OTDOA in LTE, NR specified DL-TDOA positioning measures the timing difference of DL-PRS on LOS paths from different gNBs.

Angle-based techniques-Downlink angle(s) of departure (DL-AOD): NR introduced angle-based positioning techniques. In DL-AOD, UE measures the received power based on DL-PRS and estimates the AOD from different gNBs based on the measured power difference among PRS/beam from the same transmission/reception point (TRP).

### UL-Based Solutions

Timing based technique-Uplink Time Difference of Arrival (UL-TDOA): Different from LTE, NR introduced an UL positioning technique using an UL positioning signal which is a configured UL SRS. gNBs measure the UL timing difference from the UE.

Angle-based techniques-Uplink angle(s) of arrival (UL-AOA): Similar to DL-AOD, gNBs measures the AOA from the UE using the UL SRS configured for positioning purposes. gNBs measures both zenith AOA and azimuth AOA to obtain a 3D location.

### DL- and UL-Based Solutions

Timing based technique-Multi-cell round trip time (multi-RTT): In multi-RTT, the UE measures the UE receiver-transmitter (Rx-Tx) time difference and gNBs measures the gNB Rx-Tx time difference. The RTT can be estimated with two Rx-Tx time differences for each UE-gNB pair. For Rx-Tx time difference measurement, DL PRS and UL SRS are configured and transmitted from gNBs and the UE, respectively.

Enhanced Cell-ID (E-CID): E-CID based positioning is based on RRM measurements, i.e., RSRP, RSRQ, via synchronization signals (i.e., SSB measurement) and CSI-RS. UL AOA is also supported.

The positioning method selection, configuration of the reference signals (SRS, PRS) and collection of the measurements is orchestrated by the Location Management Function (LMF) that resides in the network (TS 38.305). The LMF manages the support of different location services for target UEs, including positioning of UEs and delivery of assistance data to UEs. The LMF may interact with the serving gNB or serving ng-eNB for a target UE to obtain position measurements for the UE, including uplink measurements made by an NG-RAN and downlink measurements made by the UE that were provided to an NG-RAN as part of other functions such as for support of handover.

### Problem.

For Radio Access Technology (RAT) dependent positioning in cellular system, the procedure was well studied and specified from LTE. For NR positioning, the functions and procedures are mostly similar to that in LTE. Some new techniques and UL reference signals are introduced. However, for SL positioning, although the positioning methods may be reused, the procedures and the reference signaling, have not been defined yet. In addition, the ranging, i.e., estimating the distance of a remote object to its own location, or, as in NR, between the gNB and a UE, was not particularly addressed in NR positioning as the ranging between a gNB and a UE does not have many use cases. However, it is different in the sidelink, particular for the use cases of V2x and public safety, ranging is very important. Although ranging can be addressed with positioning, e.g., knowing the reference location and its own location, ranging requires fewer measurements and location references, so that its design can be simpler.

As described herein, multi-RTT, a timing-based positioning technique that utilizes both DL and UL measurements was specified in NR positioning. In multi-RTT, positioning reference signals, e.g., DL PRS and UL SRS are transmitted in DL and UL respectively. The UE measures the UE Rx-Tx time difference, and gNBs measures the gNB Rx-Tx time difference, where Rx-Tx time difference is the difference between the time that a radio node (UE or gNB) receives the positioning signal from the other node (gNB or UE) and the time that this radio node transmits the positioning signal subsequently. Both Rx-Tx measurements are sent to the location management function (LMF) for location estimation. With two measurements of Rx-Tx time differences on both sides of the node pair, an RTT (round trip time) is obtained, and the distance is estimated. With multiple RTTs and the reference locations of gNBs as in multi-RTT, the position of the UE is then estimated. The distance between two radio nodes, e.g., UE-to-UE or UE-to-gNB, is measured based on RTT between the two nodes, which does not need to measure the timing difference from one other node as the reference. Therefore, multi-RTT is robust to the synchronization between the gNBs. In sidelink, synchronization among multiple UEs may be difficult, which makes the multi-RTT based positioning more attractive in sidelink.

In ranging, the distance between two nodes instead of exact location of a UE is desired. Therefore, single-RTT based protocol is sufficient where RTT between the two nodes is measured. Since RTT is the traveling time of the light between the two nodes, the distance between the two nodes is than a half of the distance that the light travels during the RTT. In Wireless Fidelity (WiFi) 802.11 wireless local area network (WLAN) standard, a point-to-point single-user protocol is specified for fine timing measurement (FTM) and RTT. This protocol enables two wireless local area network (WLAN) stations to measure their distance with respect to one another, i.e., ranging.

SL positioning (including ranging) is a new area in 5G NR. So far, in general, there are no signals and methods specified in 3GPP for SL positioning. First, there is no dedicated SL signaling for positioning. Second, the SL resource selection does not support SL positioning RS transmissions and the information exchange including location information and measurement. In particular, RTT based ranging and multi-RTT based positioning is not supported with the existing SL specification.

In the present disclosure, the designs for RTT based SL ranging and positioning are provided.

### System Description For RTT Based Ranging And Positioning In Sidelink.

### RTT Based Ranging in Sidelink.

FIG. 8 illustrates the schematic diagram of sidelink ranging with a pair of UEs, where one UE (requesting UE or the ranging source UE) wants to estimate its distance to another UE (the responding UE or ranging remote UE). For RTT-based ranging, both UEs send a sidelink reference signal to each other sequentially. The reference signaling for SL ranging or positioning measurements is generally denoted as SL positioning reference signals (SL Pos-RS, or SL PRS). Each UE records the timestamp of its transmission and measures the timing (to obtain the time stamp) of receiving the SL Pos-RS from the other UE. Rx-Tx timing difference can be calculated based on the two timestamps measured at each UE. If the Rx-Tx timing difference at both UEs is known, the round-trip time (RTT) is then derived, and the distance between two UEs can be estimated. As shown, the RTT based technique requires bi-directional transmissions of the Pos-RSs between two UEs, as well as the transmission of the measurement of Rx-Tx time difference from one UE to the other UE, in particular, from responding UE to the requesting UE. Both types of transmissions use SL resource allocations. Note that since there may be multiple options or types on the Pos-RS signaling (as described herein), the type of Pos-RS from the UEs can be different.

### Multi-RTT Based Positioning in Sidelink.

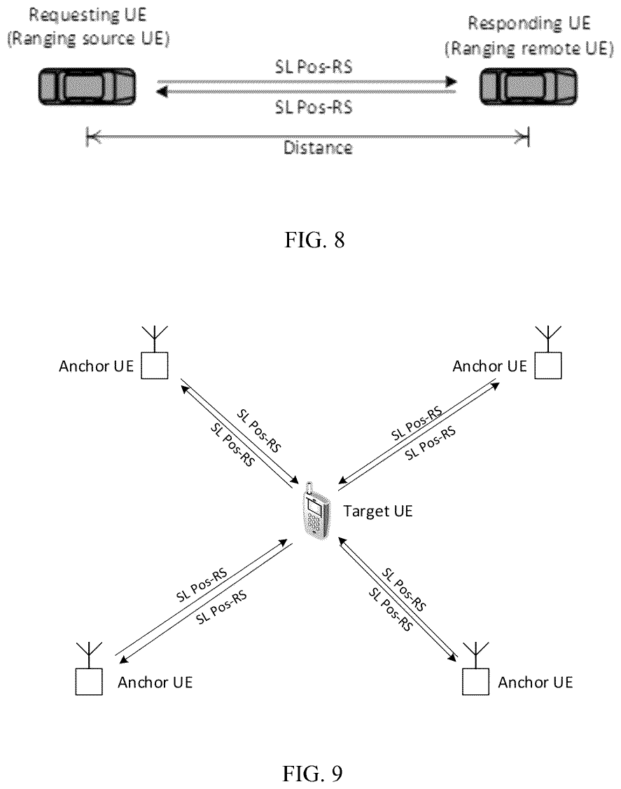

As illustrated in FIG. 9, a sidelink positioning system comprising multiple location reference UEs, i.e., anchor UEs, and a target UE is considered. Sidelink positioning is to obtain the position of the target UE based on the location information of the anchor UEs through the SL Pos-RS measurements between the target UE and anchor UEs.

For multi-RTT based positioning, the single RTT for the UE in SL ranging is extended to multiple RTT measurement for all pairs of an anchor UE and the target UE. With the distance between the target UE to each anchor UE, together with location information of each anchor UEs, the location of the target UE can then be estimated.

Same as the RTT base ranging, as shown in FIG. 9, the multi-RTT SL positioning requires bidirectional SL Pos-RS transmissions, i.e., the SL Pos-RS transmissions from an anchor UE to the target UE and from the target UE to the anchor UE. For the SL Pos-RS from anchor UEs to the target UE, separate transmissions are needed. For the SL Pos-RS from the target UE to the anchor UEs, the SL Pos-RS may be combined as one groupcast or broadcast transmission.

Unlike NR Uu link, sidelink transmissions are opportunistic and multiple transceiver links co-exist in the same resource pool. As described herein, to avoid resource allocation conflicts between different UE-to-UE links, which causes interference, sidelink transmissions are based on resource reservations either through gNB with centralized planning under gNB's coverage or through UE sensing for mode 2 operation. Transmissions of SL reference signal for positioning purposes may also need a resource reservation. Another issue for SL positioning is that anchor UEs may move or may be deployed dynamically, implying that the locations of anchor UEs may change frequently. Therefore, the anchor UEs may need to update their locations to the target UEs. Also depending on where the position of the target UE is estimated, exchange of the Rx-Tx measurements among the anchor UEs and target UE is needed. These transmissions also require resource allocations.

To achieve a certain accuracy for positioning, sufficient bandwidth for SL Pos-RS should be allocated, particularly for timing-based positioning techniques, which uses a large number of resources in a slot, which is more severe for multi-RTT based positioning as it needs the SL Pos-RS transmissions from two sides. To avoid being overwhelmed by unnecessary SL Pos-RS transmissions in a SL resource pool, efficient protocol and resource allocation are desired.

Next, the design for RTT based ranging and then extend the design to multi-RTT based SL positioning is first considered. Before describing the detailed design, the alternative terms for the UEs in SL ranging and positioning are provided below.

For SL ranging, the following alternative terms can be used:
UE request for ranging to a remote UE: the requesting UE, the (ranging) source UE, ranging initiating UE
The remote UE responding to the request: the responding UE, the remote UE, the target UE.

For SL positioning, as aforementioned, a UE who provides the location reference is termed as anchor UE and the UE whose location is to be estimated (either at the UE's itself or at an anchor UE) as the target UE. Alternatively, the following terms for the two types of UEs can be used.
UE with location reference: Anchor UE, reference UE, location reference UE, responding UE, source UE
UE with location to be estimated: positioning UE, target UE, (location) requesting UE, initiating UE

Note that there is some difference in terms of making a “request” or “initiating” in SL ranging and positioning. As will described next, in SL ranging, a UE request for ranging usually initiates the ranging process, and the request is sent to the target (remote) UE for estimating the distance to the target UE. While in SL positioning, usually the target UE whose position is to be estimated sends the request. However, in SL positioning, an anchor UE may initiate the positioning process. This anchor UE, termed as the serving anchor UE, may send an explicit request to the target UE and request the transmission of SL Pos-RS. Meanwhile, the anchor UE may need to send a different request to other anchor UEs (coordinate anchor UEs) to coordinate measurements. In such scenario, the definition of “request”/“initiating” is consistent with that in SL ranging. However, in this scenario, the anchor UE can still be called as the serving anchor UE without changing it to “request” or “initiating” UE, but not calling the target UE as requesting UE or initiating UE to avoid the confusion.

### RTT Based SL Ranging

### SL Ranging Procedures and Timestamps.

In SL ranging, one RTT is set up between two UEs, the requesting UE for ranging estimation and the responding UE as the reference UE of the ranging.

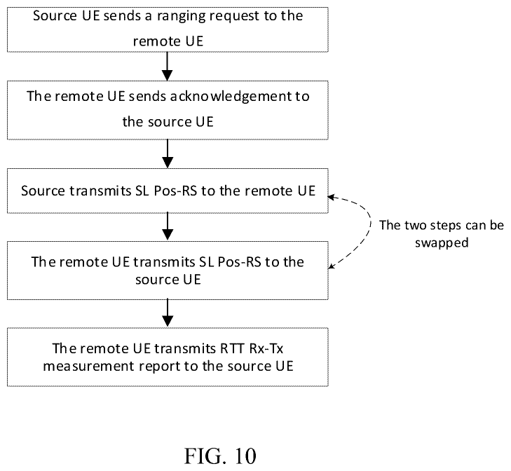

As shown in FIG. 10, first, the source UE or the ranging requesting UE sends an explicit request for ranging to the target remote UE. The target UE responds to the source UE. After that, the transmissions of SL Pos-RS for time measurement from one to the other starts. The requesting UE can transmit a request with the SL Pos-RS on the same slot or same resource reservation. The responding UE may also send the SL Pos-RS with a responding message or simply SL Pos-RS without a responding message. The responding UE then sends the timing measurement to the requesting or source UE for the UE to estimate the range based on the RTT. The request can be sent dynamically via 2nd SCI or a MAC-CE to the remote UE.

FIG. 10 is a flowchart for SL ranging. The Rx-Tx measurement report can be multiplexed with SL Pos-RS or encoded in the SL Pos-RS. If encoded in the SL Pos-RS, then a separate transmission of measurement report is not needed.

In one embodiment, a transmission from the requesting UE is followed by a transmission from the responding UE. The sequence may repeat for fixed number of times, for instance (pre-) configured, or indicated by the requesting UE. In a different embodiment, the requesting UE does not specify the number of such exchanges but rather a time limit when such exchanges are permitted.

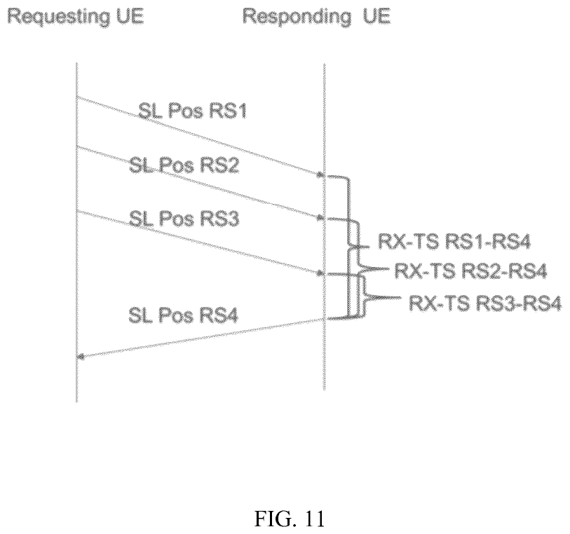

FIG. 11 is an illustration of SL Pos-RS transmissions in SL ranging, e.g., multiple SL Pos-RS transmissions from requesting UE before a transmission from responding UE. In a different embodiment, the requesting UE and the responding UE may send a different number of transmissions of SL Pos-RS. For instance, the requesting UE may send two to three such transmissions, followed by (for instance) a single transmission SL Pos-RS from responding UE, as shown in FIG. 11. The responding UE will measure the time difference from each received signal to each of its transmitted SL Pos-RS signals and provide them to the requesting UE. In this embodiment, the requesting UE may indicate to the responding UE how many SL Pos-RS transmissions to send and how many are expected to be received. In this embodiment, the transmission signals do not need to be regularly interleaved, i.e., one after the other, as long the measurements for each received SL Pos-RS to each transmit SL Pos-RS are provided.

Since in RTT based SL ranging, the signal or information exchanges are between two SL UEs. Unicast is an appropriate transmission cast type. The request or the configuration of the SL Pos-RS transmissions can be sent via a PC5 interface to radio resource control (PC5-RRC). The remote UE and requesting UE may send the SL Pos-RS on multiple slots, e.g., periodically with a certain interval, for a certain period. The remote UE may send multiple the Rx-Tx (or Tx-Rx) measurements to the requesting UE sequentially or in one transmission.

Indication of Responding UE: The remote UE may indicate whether it supports the RTT based ranging and/or positioning or whether it can be the responding UE at the moment. The indication can be an RRC signal exchange or in the responding message. For instance, if the requesting UE indicates and makes a reservation for HARQ feedback, the response may be signaled in PSFCH. Example of such indications may be different codes (spreading codes).

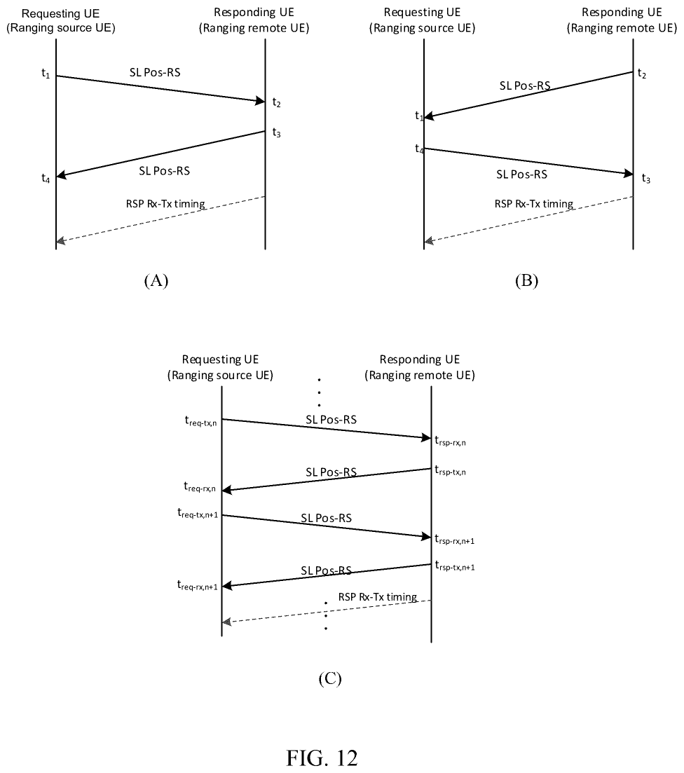

The message flow for RTT based SL ranging is illustrated in FIG. 12. FIG. 12 illustrates message flow in RTT based SL Ranging (A) Requesting UE sends the SL Pos-RS first (B) Responding UE sends the SL Pos-RS first (C) Requesting UE and responding UE send SL Pos-RS for a certain period. In FIGS. 12(A) and (B), one RTT with two Pos-RS transmissions, one from each UE, are depicted. As shown in FIG. 12(A), the SL Pos-RS is first sent from the requesting UE while in FIG. 12(B) the SL Pos-RS is first sent from the responding UE. After one round of SL Pos-RS transmissions, the responding UE sends the Rx-Tx timing measurement to the requesting UE. In FIG. 12(C), multiple SL Pos-RSs are sent from each UEs. Multiple timing measurements are obtained which can improve the ranging accuracy. For high mobility UEs, the distance change can be captured with multiple measurements and the estimation of the latest distance can also be improved.

Without loss of generality, the one round of RTT illustrated in FIG. 12(A) is used to discuss the timing for the present proposals in the sequel. Below are the four timestamps in one round of RTT transmissions.
The requesting UE first sends the SL Pos-RS signal at t₁.
The responding UE receives the SL Pos-RS at t₂ and transmits the responding signal, e.g., SL Pos-RS, at t₃.
The requesting UE receives the signal from responding UE at t₄.
After t₄ the responding UE then sends Rx-Tx timing (t₃-t₂) measurement report to the requesting UE

The Rx-Tx measurement at responding UE 2 is the measurement of t₃-t₂. The Rx-Tx measurement at requesting UE 1 is the measurement of t₄-t₁. The ranging or the distance between requesting UE and responding UE is then calculated at:

$${D}_{1 , 2} = c \cdot \frac{( {t}_{4} - {t}_{1} ) - ( {t}_{3} - {t}_{2} )}{2} ,$$

where c is the speed of light.

If following the fine timing measurement (FTM) protocol in the Institute of Electrical and Electronics Engineers (IEEE) 802.11 spec, the values of timestamps t₂ and t₃ are reported to the requesting UE. In multi-RTT for NR positioning, the Rx-Tx measurement t₃-t₂ is reported to the LMF.

For absolute location estimation, i.e., positioning, multiple RTT (multi-RTT) measurements from different responding UEs are needed. The minimum requirement for positioning is three RTTs.

Cast type: In RTT based SL ranging, the SL Pos-RS transmission and measurement reports are between the request and the responding UEs. Therefore, the appropriate cast type for these transmissions is unicast, which may be sufficient for ranging purpose.

### RTT Timing Analysis and Measurement Report.

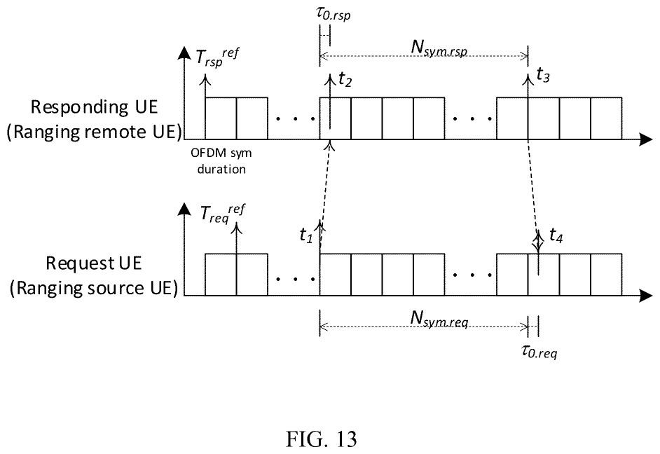

The timestamp can be the time according to a reference OFDM symbol. As shown in FIG. 13, the reference symbols at requesting UE and responding UE can be different, i.e., T_{req}^{ref} and Tᵣₛₚ^{ref}. Then timestamp can then be an offset of OFDM symbols from the reference time T_{sym,i} plus a fraction time of OFDM symbol duration τ_{0,i}. Therefore, the general description of the four timestamps are as:

$${t}_{i} = {T}_{rsp}^{ref} + {T}_{sym , i} + {τ}_{0 , i} , i = 2 , 3$$

$${t}_{i} = {T}_{r e q}^{ref} + {T}_{sym , i} + {τ}_{0 , i} , i = 1 , 4$$

For the transmission, t₁ and t₃ are the timestamps of the transmission OFDM symbols that can be aligned with the reference OFDM symbol with τ_{0,i}=0. When the OFDM symbol sampling is also aligned within the OFDM symbol intervals, the delay τ_{0,i} can represent the relative line of sight (LOS) channel path delay from one UE to the other. Nevertheless, the general expressions in (1) are considered.

The Rx-Tx measurements are obtained at the responding UE and requesting UE, respectively, given by:

$${t}_{3} - {t}_{2} = {T}_{sym , 3} + {τ}_{0 , 3} - ( {T}_{sym , 2} + {τ}_{0 , 2} ) = {N}_{sym , rsp} - {τ}_{0 , rsp} ,$$

$${t}_{4} - {t}_{1} = {T}_{sym , 4} + {τ}_{0 , 4} - ( {T}_{sym , 1} + {τ}_{0 , 1} ) = {N}_{sym , req} + {τ}_{0 , req} ,$$

where N_{sym,rsp}=T_{sym,3}-T_{sym,2}, N_{sym,req}=T_{sym,4}-T_{sym,1}, τ_{0,rsp}=τ_{0,2}-τ0,3, and τ_{0,req}=τ_{0,4}-τ_{0,1}. As discussed above, if τ_{0,1}=τ_{0,3}=0, then τ_{0,rsp}=τ_{0,2} and τ_{0,req}=τ_{0,4}. Then:

$${D}_{1 , 2} = c \cdot \frac{( {N}_{sym , req} - {N}_{sym , rsp} ) + ( {τ}_{0 , req} + {τ}_{0 , rsp} )}{2} \qquad ( 1 )$$

If D_{1,2} is small enough and the RTT is within an OFDM symbol duration, we then have N_{sym,req}=N_{sym,rsp}. Then the distance is solely dependent of the two relative timing offset, i.e.,

$${D}_{1 , 2} = c \cdot \frac{( {τ}_{0 , r e q} + {τ}_{0 , rsp} )}{2}$$

For RTT based SL ranging and positioning method, for each RTT, a responding UE needs to send t₂ and t₃ or direct quantization of Rx-Tx timing difference (t₃-t₂) to the requesting UE. With decoupled Rx-Tx timing difference, the responding UE can alternatively send the number of OFDM symbols, N_{sym,rsp}, and relative timing offset τ_{0,rsp} to the ranging/positioning requesting UE. If assuming N_{sym,req}=N_{sym,rsp}, the responding UE can simply send the timing offset τ_{0,rsp} to the requesting UE. It may be possible that the two SL Pos-RS transmissions are on different bandwidth parts (BWPs) with different SCS from the transmission. In this case, responding UE and requesting UE may use different reference SCS to calculate the number of OFDM symbols. Since SCS is specified with 15*2^{μ} kHz, the number of symbols can be transformed to one with the same reference SCS, e.g., SCS with μ=0, such as N_{sym,req}/2^{μ}^{_{req}}, N_{sym,rsp}/2^{μ}^{ᵣₛₚ} to translate it to the number of OFDM symbols of 15 kHz SCS.

### Encoded Timing Measurement Reporting for SL Ranging and Positioning.

### Phase Encoding.

Instead of sending τ_{0,rsp}, the responding UE can also encode the timing offset information in the SL Pos-RS signal without additional transmissions. Assume the SL Pos-RS in an OFDM symbol is sₖ where k∈S_{Pos-RS} is the subcarrier index. Instead of transmitting sₖ, the responding UE sends:

S′_{rsp,k}=s_{rsp,k}e^{-j2πkf}^{_{sc}}^{τ}^{_{0,rsp}}.

Assuming a LOS channel with the first path delay τ_{0,req},

$${h}_{r e q} ( τ ) = {\sum }_{l = 0}^{L - 1} {c}_{l} δ ( τ - {τ}_{l , req} )$$

With the time domain OFDM signal carrying s′_{rsp,k}, the received signal at requesting UE is then:

$${\hat{y}}_{rsp , k}^{′} = {\sum }_{l = 0}^{L} {c}_{l} {{s}^{′}}_{rsp , k} {e}^{- j 2 π {kf}_{sc} {τ}_{l , req}} = {\sum }_{l = 0}^{L} {c}_{l} {s}_{rsp , k} {e}^{- j 2 π {kf}_{sc} ( {τ}_{0 , rsp ,} {τ}_{l , req} )} = {s}_{rsp , k} {e}^{- j 2 π {kf}_{sc} ( {τ}_{0 , rsp ,} {τ}_{0 , req} )} + {\sum }_{l = 1}^{L} {c}_{l} {s}_{rsp , k} {e}^{- j 2 π {kf}_{sc} ( {τ}_{0 , rsp ,} {τ}_{l , req} )}$$

The first path is now with effective delay component τ_{0,rsp}+τ_{0,req}. The requesting UE can now measure τ_{0,rsp}+τ_{0,reg} without need of the information exchange.

### Sequence/Cover Code Encoding.

Instead of encoding the timing offset on the phase, the timing offset may be encoded with a sequence. Given a specified quantization granularity for timing offset τ_{0,rsp}, we then have a maximal number of bit representation, e.g., B bits. The maximum is then 2^{B}. 2^{B} sequences of length M, denoted as aᵢ=[a_{i,1}, . . . , a_{i,M}], i=1, . . . , 2^{B} can be specified. Then for each τ_{0,rsp}, there is a mapped aᵢ, the transmitted symbols is then encoded as:

S′_{rsp,k}=s_{rsp,k}a_{i,k}.

The received signal on the frequency domain at the requesting UE is then given by:

$${\hat{y}}_{rsp , k}^{′} = {\sum }_{l = 0}^{L} {c}_{l} {a}_{i , k} {{s}^{′}}_{rsp , k} {e}^{- j 2 π {kf}_{sc} {τ}_{l , req}} = {c}_{0} {a}_{i , k} {s}_{rsp , k} {e}^{- j 2 π {kf}_{sc} {τ}_{0 , req}} + {\sum }_{l = 1}^{L} {c}_{l} {a}_{i , k} {s}_{rsp , k} {e}^{- j 2 π {kf}_{sc} {τ}_{l , req}}$$

With received signal ŷ′_{rsp,k}, k=1, . . . , M, the receiver can perform either joint sequence detection and channel estimation to estimate aᵢ and τ_{1,req} or sequential detection of aᵢ and τ_{1,req}. With aᵢ estimated, the requesting UE or the target UE then obtains the information of τ_{0,rsp}.

It can be seen that aᵢ design is dependent of the length, i.e., the size of positioning signal which can be variable. The code sequence set can be specified to cover each variation of positioning signal reference. The set of sequences with fewer choices can also be specified and apply it when M<M_{Pos-RS}, where M_{Pos-RS} is size of SL Pos-RS in an OFDM symbol. Leaving some SL Pos-RS REs unmasked will reduce the complexity and/or improve the performance of the channel/delay estimation and sequence detection at the receiver UE.

### Signal Options For RTT Based SL Ranging And Positioning

As aforementioned, SL Pos-RS is used to denote general positioning reference signal. These reference signals and potential configurations for RTT based SL ranging and positioning are discussed.

### S-SSB and SL CSI-RS.

S-SSB and SL CSI-RS can be used as the SL Pos-RS. For timing-based techniques, e. g., the RTT based SL ranging and positioning, the small bandwidth of S-SSB or the sparsity of CSI-RS may have large impacts on the ranging and positioning accuracy. However, the two reference signals may still be used to provide a certain coarse estimation on the ranging distance and the locations.

In one embodiment, a requesting UE sends to a responding UE a request that indicates that a RTT ranging based on the S-SSB is requested. In this embodiment, there are S-SSB transmissions from either side (requesting and responding UE) for the purpose of ranging. The responding UE will measure the time interval between the last received S-SSB from the requesting UE and its own S-SSB transmission. This measurement will be provided to the requesting UE for range estimation purposes. The requesting UE will measure the time difference between its own transmitted S-SSB and the following S-SSB received from the responding UE, and together with the measurement from the responding UE it will estimate the distance (range) between the two devices. In this embodiment the requesting UE may indicate to the responding UE the number of times when the responding UE is requested to send this measurement.

A similar operation may be defined, in a different embodiment, by using CSI-RS from requesting UE and CSI-RS from responding UE or combinations of S-SSB from requesting and CSI-RS from the responding or the other way around.

SL Pos-RS based on UL SRS for Positioning (SL PRS or SL SRS).

Since the bandwidth of S-SSB is small, and density of CSI-RS is low, they may not be appropriate as the SL Pos-RS for positioning with high accuracy requirement. New SL Pos-RS is desired. In Rel-16, UL SRS has been expanded with more signals for positioning purposes. Since UL SRS is designed for UE transmissions, it is possible to use the UL SRS for RTT based SL ranging and positioning, i.e., one of SL Pos-RS.

As described herein, the following can be configured on UL SRS for positioning.
Comb size K_{TC}: 2, 4, 8
Number of OFDM symbols for UL SRS N_{symb}^{SRS}∈{1,2,4,8,12}
The starting OFDM symbol defined by an offset 1_{offse}
Frequency domain offset
SRS sequence ID
Time domain periodicity and offset
SRS bandwidth (BW) or number of PRBs

The SRS as SL Pos-RS can be configured via one of the following alternative approaches.
The SRS configurations are provided in the request message.
Various (pre-)configuration of SRS for SL ranging and/or positioning, e.g., in a SL-SRS-PosResourceSet or multiple SL-SRS-PosResourceSets. Upon the request of SL ranging or triggering of SL positioning, a (pre-)configured SL SRS for positioning is transmitted. Alternative to pre-configuration, configuration can be set with PC5 RRC signalling or indicated in the request message.

Since the BW of the reference signal is important for timing estimation, consequently, the positioning accuracy in RTT based ranging and positioning, the configuration of SRS BW or the number of PRBs for SRS as SL Pos-RS is important. The number of subchannels for SL SRS transmissions can be (pre-)configured. For SL positioning, the number of subchannels for SRS can be specified in a range with a lower bound on minimum number of subchannels (or minimum number of PRBs) and an upper bound on maximum number of subchannels (or maximum number of PRBs). The upper bound can be the total number of subchannels or PRBs in a SL resource pool. Anchor UEs need to reserve the resources for transmitting SL PRS. For efficient transmission, the configuration on BW/number of PRBs for SL PRS may be in a range or a minimum number of subchannels (or minimum number of PRBs). The responding UE or anchor UE may decide the actual number of subchannels for SL PRS transmissions.

### Psfch Signaling.

In RTT based ranging and positioning, the responding UE or the anchor UE needs to send the SL Pos-RS, e.g., SL PRS, in responding to the SL Pos-RS transmit from the ranging requesting UE or the target UE within a certain time gap. Instead of sending SL-PRS, alternatively, the responding UE or the anchor UE can send the SL Pos-RS using PSFCH sequence and transmitted in PSFCH channel resources.

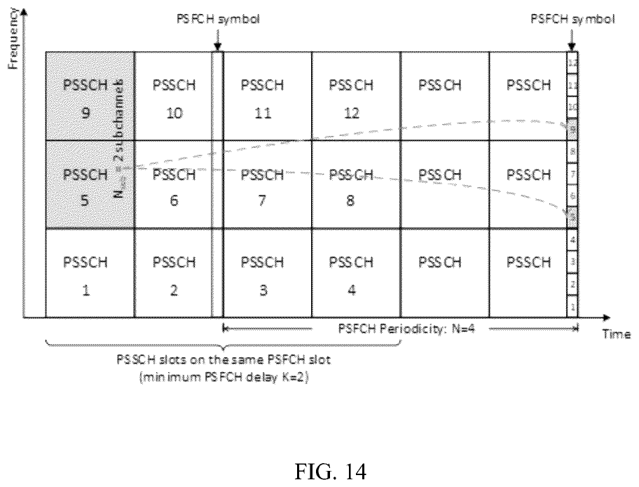

As shown in FIG. 14, for PSFCH, there is a slot gap based on PSSCH-to-PSFCH timing specified in TS38.213 to determine the PSFCH time occasion. Since SL PRS is sent in PSSCH, the PSSCH-to-PSFCH timing can be used to determine the slot occasion of the responding signal. Then the PSFCH sequence on PSFCH channel is used as the SL Pos-RS.

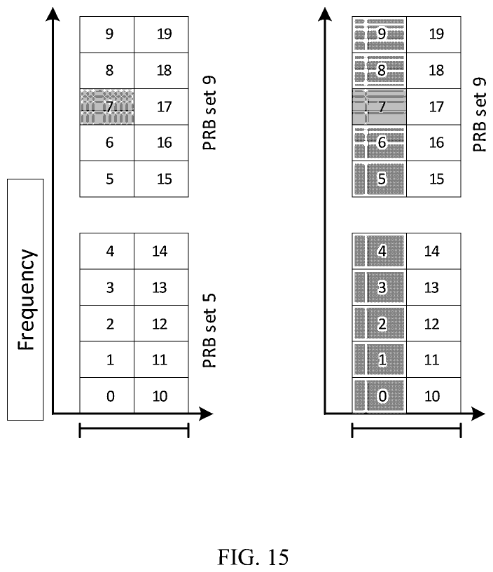

However, also shown in FIG. 14 and FIG. 15(A), the PSFCH for HARQ-ACK and the conflict report in Rel-17 occupies one PRB in the PRB set for HARQ-ACK or conflict report in IUC, which is far from necessary bandwidth for timing measurement.

The present disclosure provides a solution to increase the bandwidth of the PSFCH signaling on the PSFCH symbol in a resource pool. For subchannels of initial SL PRS transmission, there are multiple PRB sets which form a PSFCH PRB pool, also illustrated in FIG. 14 and FIG. 15(A). With a different cyclic shift of the PSFCH sequence, the PSFCH PRB pool is expanded in the code domain. For PSFCH HARQ-ACK, one PSFCH PRB is selected with PSFCH index derived based on configurations, as illustrated in FIG. 15(A). For RTT based SL ranging and positioning, as shown in FIG. 15(B), instead of using one PSFCH PRB, other PSFCHs in the same PRB set may also be used as SL Pos-RS.

If with data, the mapped PSFCH HARQ-ACK can be excluded. Or alternatively, the PSFCH HARQ-ACK can be reused for positioning/ranging purpose too after it is decoded. Alternatively, to avoid the conflict between PSFCH HARQ-ACK and PSFCH for SL ranging/positioning, a cyclic shift that is different on PSFCH HARQ-ACK in the code domain, i.e., parameter m0 specified in TS38.213, can be used. For example, in FIG. 15(B), if PRB 7 is used for HARQ-ACK, instead of using PSFCH channels 0-9 for SL Pos-RS, the PSFCH channels 10-19 are used for PSFCH as SL Pos-RS.

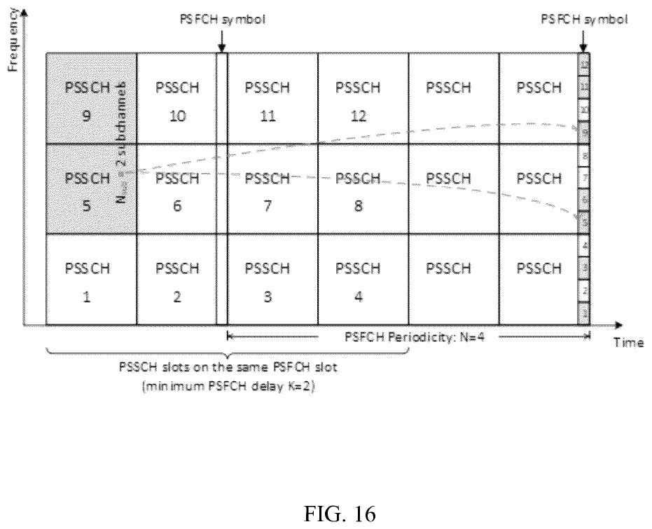

In addition, the PRB sets that are not configured for HARQ-ACK can be used as SL Pos-RS resources. As shown in FIG. 16, additional PRB sets {1,3,6,11,12} are configured for responding SL Pos-RS in RTT based ranging and positioning.

In PSFCH HARQ-ACK, the ACK or NACK state is based on an additional cyclic shift parameter m_{CS}, i.e., m_{CS}=0 for ACK and m_{CS}=1 for NACK. As SL Pos-RS, these two states to configure two responding signals for different initial SL Pos-RS transmissions can be used if they can share the resources on the same slot. Or alternatively, for simplicity, the setting of m_{CS} can be fixed, e.g., m_{CS}=0.

Since the UE has a maximum transmission power, power may be a limiting factor for configuring the number of PSFCH PRBs for positioning reference signal. Using many RBs decreases the transmit power per resource element (RE). Therefore, configuring number of PSFCH PRBs should consider the tradeoff between the transmission power per RE and positioning accuracy. This issue is not only for the PSFCH as an SL Pos-RS. It is generally applied to any SL Pos-RS with configurable PRBs in an OFDM symbol.

### Multi-RTT Based Sidelink Positioning.

Indication and Availability of Anchor UEs for multi-RTT Positioning.

Anchor UEs serve as the reference UEs with known locations. A UE which supports sidelink positioning and capable of being an anchor UEs for location function can be an anchor UE. As described later, the target UE may request the positioning reference signaling, location information, or the measurements from the anchor UEs. In one embodiment, an anchor UE (or positioning reference UE) signals other UEs that it can be an anchor UE.

If a UE is capable of being an anchor UE, the UE may not always want to serve as an anchor UE. The UE may also not meet a certain condition to be an anchor UE. Therefore, the indication of anchor UEs, i.e., a UE may indicate via periodic, semi-static or dynamic signaling that it can be an anchor UE for sidelink positioning is proposed. For better positioning accuracy, it is better that the target UE can synchronize with each of anchor UEs. However, this is not necessary for some positioning methods such as multi-RTT. The SL synchronization can be achieved via S-SSB. Since S-SSB is sent periodically, the anchor UE can indicate its availability for positioning as a anchor UE via reserved bits in PSBCH transmitted in S-SSB. The PSBCH carries the SL master information block (SL-MIB), For instance, one reserved bit in PSBCH in S-SSB indicates whether the UE can be anchor UE or not. Alternatively, for more dynamic indication, the UE can use a reserved bit in SCI format 1-A. The indication can also be provided through RRC signaling.

The anchor indication can be enabled/disabled by (pre-)configuration, which is mostly for dynamic indications, e.g., using a reserved bit in SL-MIB or PSCCH SCI-1A. Note that the indication is in addition to signal exchange of the UE capabilities.

The anchor availability indication and the support of specific positioning methods may be indicated in various ways. For instance, the anchor indication can be available for all supported SL positioning techniques. Alternatively, it may be specified to a subset of positioning techniques, e.g., timing based and/or angle-based techniques. In E-SID positioning based on signal strength (e.g., RSRP) measurement, it may not need a dynamic indication. The capability signaling exchange of UE features between the target UE and an anchor UE may be used for above signaling. RTT based ranging or multi-RTT based positioning need more signaling exchange, such as Rx-Tx time difference measurement. The RTT based capability is different from the timing-based techniques. The indication can be different. There may be different indications for different positioning techniques. With separate indications, more bits need to be specified. Examples of such indications may be bitmaps, entry of a table indication each combination, etc.

One alternative way is to use the reserved bit in SL-MIB as general indication that the UE can be an anchor UE. The request from the target UE can be a specific request for a particular positioning technique or general request for positioning. Upon a request, the potential anchor UE can send a responding message or acknowledgement where it can be the anchor UE for a particular positioning technique, e.g., multi-RTT based SL positioning, that UE requests, or indication of a list of positioning techniques that it supports if the target UE sends a general request for positioning. The response message from responding UE can be sent in second stage SCI (SCI format 2-x) or MAC-CE. For simple response, the responding UE may send acknowledge with a PSFCH. The PSFCH occasion for acknowledgement may be on the same slot as that for PSFCH HARQ-ACK, i.e., same PSSCH-PSFCH mapping for the PSSCH where the request is sent. The PSFCH PRB or the cyclic shift may be different with the PSFCH HARQ-ACK.

In one embodiment, an anchor UE advertises its availability for one or more positioning procedures/techniques, via RRC exchange, MAC CE, reply to a positioning RS request for instance via HARQ over PSFCH or exchange of UE features. Optionally, the anchor UE may also broadcast its absolute location. Such an anchor UE is expected to broadcast its S-SSB. An anchor UE may also indicate its sync source for its location estimation, e.g., GNSS, or gNB when in partial coverage.

In one embodiment, a UE in SL discontinuous reception (DRX) mode may advertise (in system information block (SIB) for instance) its availability in time domain, e.g., SL DRX active time, so that the target UE decides whether the UE can be its anchor UE given its availability. The SL DRX active time of a candidate anchor UE can also be sent in the responding message to the target UE who requests SL positioning or multi-RTT based positioning.

### Multi-RTT SL Positioning Procedures and Pos-RS Transmissions.

The RTT based SL ranging can be extended to multi-RTT SL positioning.

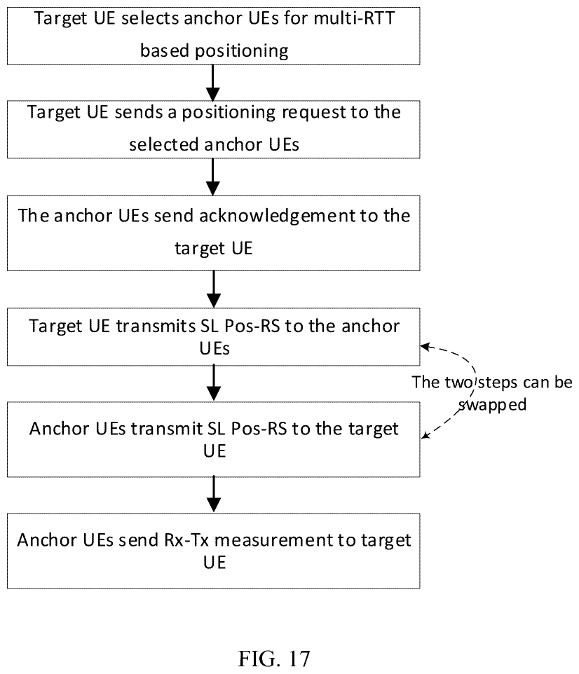

As shown in FIG. 17, first, the target UE discovers the available candidate anchor UEs for positioning or for multi-RTT SL positioning based on the indication of the UEs or the positioning capability of the candidate anchor UEs. The target UE selects a group of candidate anchor UEs.

In one embodiment, the selection of the anchor devices is based on their source of synchronization, their received signal strength, their support of anchor features, location zone, mobility (Doppler shift) etc. In one embodiment, the target UE sends the request for positioning, or specifically, for multi-RTT SL positioning to each UE in the group and waits for the responding message or acknowledgement message from each UE. Alternatively, the target UE groupcasts the request to the group or broadcasts the request. If the target UE broadcasts the request, the target UE does not need to select a group of candidate anchor UEs first.

Based on the responding message from the candidate anchor UEs, the target UE selects the group of anchor UEs for multi-RTT SL positioning. Another round of information exchange, e.g., SL Pos-RS configurations for each anchor UEs from the requesting UE, may be done before the SL Pos-RS transmissions from each UEs. For Rx-Tx measurements, one round of SL Pos-RS may be enough. The SL Pos-RS transmissions may be started from either the target UE or an anchor UE based on the configuration. Such configuration may be in the request message, responding message, or the (pre-)configurations of the resource pool. Multiple SL Pos-RS transmissions from either side, either periodic or aperiodic, in a (pre-)configured time duration can be specified. For multiple SL Pos-RS transmissions, the Rx-Tx measurement report needs to include the Rx and Tx SL Pos-RS information, e.g., Rx and Tx SL Pos-RS slot or Rx and Tx SL Pos-RS OFDM symbol.

The RTT process of SL Pos-RS transmissions and obtaining Rx-Tx measurement reports can be performed between the target UE and each anchor UE sequentially (one anchor UE after another anchor UE). The request and response for each RTT estimation may be per unicast basis. Then for better positioning accuracy, the RTT process for each pair is limited by a specified maximum delay. However, for moderate or high mobility, The RTT processes can be performed in a parallel manner, i.e., the target UE sends the SL Pos-RS to each anchor UE without completing the RTT process or Rx-Tx measurement for an anchor UE, and an anchor UE may also send the responding SL Pos-RS either before or after receiving the SL Pos-RS from the target UE. The anchor UE then sends the Rx-Tx measurement report to the target UE. The request and response for each RTT between the target UE and an anchor UE can still be per unicast basis. However, alternatively, the target UE may groupcast or broadcast the SL Pos-RS to the anchor UE with one resource allocation for one SL Pos-RS transmissions to all anchor UEs. This may be more efficient for multiple SL Pos-RS transmissions in a certain duration.

The efficient encoding of relative timing offset, i.e., the fractional timing of an OFDM symbol duration, described herein can be also applied to multi-RTT SL positioning for efficient Rx-Tx measurement reporting. For efficient encoding, if the positioning (location estimation) is performed at the target UE, the target UE should start the SL Pos-RS transmission first. If the positioning is performed at an anchor UE (termed as serving anchor UE), the anchor UE should transmit the SL Pos-RS first. Also in this case, the target UE needs to send the SL Pos-RS separately to the serving anchor UE with each transmission encoded with a timing offset from one anchor UE.

The PSFCH as the responding SL Pos-RS described herein can be applied to multi-RTT SL positioning. With PSFCH as SL Pos-RS, the timing gap between the Rx SL Pos-RS and the transmission of SL PSFCH is guaranteed. Therefore, the number of OFDM symbol durations, N_{sym,rsp}, is known to the PSFCH receiver. Since the PSFCH sequence is known to the PSFCH receiver, the efficient encoding of the timing offset, τ_{0,rsp}, can be applied too. With the efficient encoding of τ_{0,rsp}, no additional resources for Rx-Tx measurement report at each anchor UE is needed.

Instead of SL PRS as the SL Pos-RS, alternatively, the target UE and the anchor UEs rely on S-SSB for multi-RTT SL positioning. The target UE requests anchor UEs to send their UE Rx-Tx timing with respect to the S-SSBs. Upon request, the anchor UEs provides UE Rx-Tx measurements to the target UE. The target UE also relies on S-SSBs from the anchor UEs to obtain the Rx-Tx measurement. With the Rx-Tx measurement reports from the anchor UEs, the target computes its location.

Instead of one type of SL Pos-RS, the Rx-Tx measurement can be obtained based on the combination of other SL signals such as S-SSB and CSI-RS, or CSI-RS and SL PRS, etc.

Multi-target ranging in sidelink.

Multi-target ranging can be realized with multiple single-target ranging as described herein independently. However, it would be more efficient to apply the procedures, particularly, the SL Pos-RS (request and responding) transmissions, designed for multi-RTT SL positioning. The main difference is that the location information of the anchor UEs (now the ranging remote UEs) are not needed at the ranging requesting UE.

### Cast Type in Multi-RTT SL Positioning.

For the cast type of transmission of request from the requesting UE, one or more of following alternatives are supported.

Unicast: the target UE sends the request to each anchor UE independently
Groupcast: a group of anchor UEs is formed by the upper layer after anchor UE selection. The target UE groupcasts the request to the group of anchor UEs.
Broadcast: a UE may broadcast its request. The UEs that supports SL positioning, or specifically, multi-RTT based SL positioning, and satisfy certain (pre-)configured constraints/conditions (location-zone, RSRP, requirement on its sync source/location information) may respond to the target UE.

For the responding message or acknowledgement, unicast is supported.

For the SL Pos-RS transmissions from either side, unicast is supported. In addition, the Pos-RS transmitted from the target UE to anchor UE can be groupcast or broadcast if SL PRS is used.

For Rx-Tx measurement report from the anchor UE to the target UE, due to distinct Rx-Tx timing, unicast is used. In some scenarios, e.g., roadside units (RSUs) as anchor UEs, broadcast is also useful thus is preferred when the interaction between anchor UEs and the target UE on other information is limited. The location information of the anchor UEs can also be broadcast to every UE either multiplexed with SL PRS transmission or in a separate transmission. With groupcast or broadcast of the SL Pos-RS from the target UE, each anchor UE may transmit the Rx-Tx measurement on one received SL Pos-RS (e.g., most recent one from the target UE) referenced to one of transmitted Pos-RS (e.g., the most recent one) to the target UE. For multiple target UEs in the coverage, the anchor UE needs to send the Rx-Tx measurement report to each target UE via unicast.

In the sidelink, there is no SIB message to deliver the UE's location information. For SL positioning, the location information of the anchor UE needs to be shared with the target UE. The location information can be transmitted to the target UE via unicast, groupcast, or broadcast. It can be multiplexed with the SL Pos-RS sent to the target UE if the cast types for two transmissions are the same.

### SL Resource Allocation.

Resource allocations are needed for various transmissions during the SL position process, e.g.:
Transmission of positioning request
Transmission of SL Pos-RS (SL PRS, SL CSI-RS)
Transmission of Rx-Tx measurement report
Transmission of anchor UE's location information

In general, each Tx UE can select resources for its own transmission based on (pre-) configured transmission settings, e.g., periodicity, etc. The Rx-Tx measurement report or the location information can be multiplexed with the SL Pos-RS transmissions.

The resources may be reserved for periodic SL Pos-RS transmissions. A special indication via a reserved bit in SCI 1-A or second stage SCI can be specified on the resources reserved for SL Pos-RS transmissions.

To avoid conflicts, the target UE may send the preferred resource set for each anchor UE for transmissions of either SL Pos-RS or the anchor UE's location information. The priority of SL Pos-RS and location information may be (pre-)configured. The priority of location information may be associated with or determined based on its sync source.

For multi-RTT, a maximum timing gap between Rx and Tx is specified. The timing gap can be used as PDB for the reservation of Tx transmissions following the most recent Rx of SL Pos-RS from the other side. For multiple or periodic SL Pos-RS transmissions, the interval of the two transmissions is also subject to the restriction of maximum timing gap.

Due to SL Pos-RS transmissions from both sides, the anchor UE and the target UE, in multi-RTT based sidelink positioning, it may be more efficient if some anchor UEs can group their SL Pos-RS, e.g., SL PRS/SRS, and transmit in the same resources on the same slot. For instance, based on the SL PRS configurations, the serving anchor UE or the target UE send a request so that the anchor UEs can send SL Pos-RS synchronized in one or several slots.

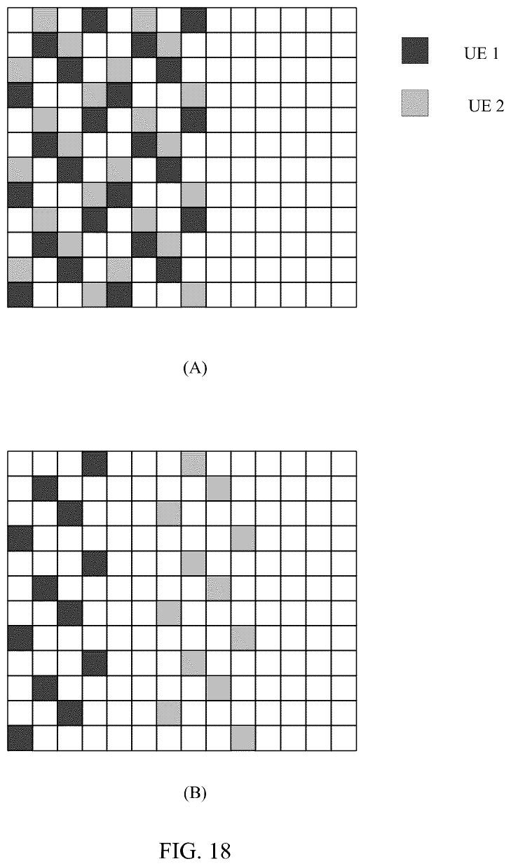

FIG. 18 illustrates two UL SRS (as SL PRS) transmissions on the same slot in sidelink (A) Interleaved (e.g., overlapping patterns) SRSs (comb size K_{TC}=4 on N_{symb}^{SRS}=8 OFDM symbols in a slot) (B) Disjoint SRSs (e.g., separate regions) in the time domain (comb size K_{TC}=4 and each on N_{symb}^{SRS}=4 OFDM symbols in a slot). A similar mapping is possible with SL PRS.

As shown in FIG. 18, two configured SRSs are transmitted in one reserved resource block, i.e., in shared resources. In this case, one of the anchor UEs may send the PSCCH indicating the reserved resources. The configuration of such grouping SRS is either known to the target UE (e.g., requested by the target UE) or is informed to the target UE via the 2nd SCI or the MAC-CE multiplexed in the SL PRS transmissions. To mitigate the interference on SRSs from the different UEs, the grouping may be based on a rough distance of the anchor UEs from the target UEs, e.g., via RSRP measurements from S-SSB transmissions. As shown in FIG. 18(B), one other solution is to configure each SRS with different offset so that there is one or more guard symbol between two SRS's in time domain. In this case, the number of OFDM symbols for each SRS is 4 or less.

Resource allocation of Positioning in Unlicensed spectrum.

In unlicensed spectrum, to access the channel, listen before talk (LBT) based clear channel assessment (CCA) is required before the transmissions. However, one exception is for Short Control Signaling Transmissions which is used by the UE to send management and control frames without sensing the channel for the presence of other signals. If SL Pos-RS is short enough, i.e., number of OFDM symbols for SL PRS is below a threshold, it can be considered a Short Control Signaling Transmissions. By considering the SL Pos-RS as short control signaling, LBT based CCA can be avoided.

The limitation of the Short Control Signaling Transmissions is 1) within an observation period of 50 ms, the number of Short Control Signaling Transmissions should be equal to or less than 50; 2) the total duration of such transmissions should be less than 2500 ms within the observation period. For some scenarios, e.g., RTT based SL ranging with few SL PRS transmissions, or SL positioning with few anchors of high-quality (good LOS channel quality, high level sync source, etc.), the limitation may not be an issue as it does not require many or long SL Pos-RS transmissions.

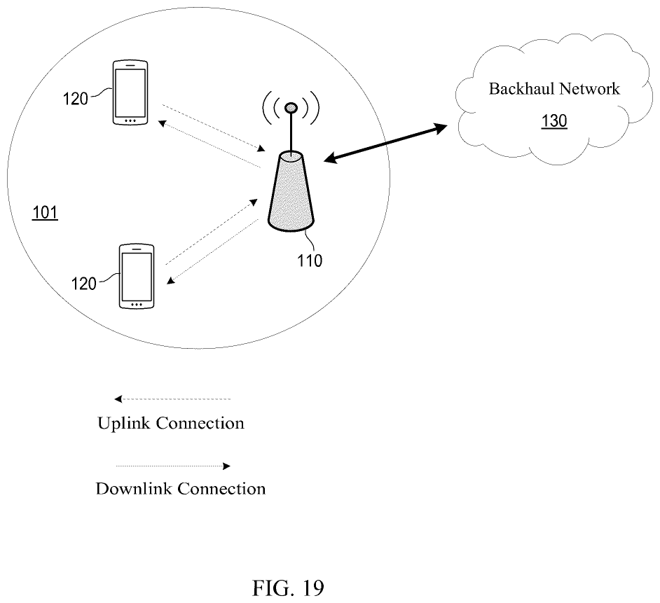

FIG. 19 illustrates a network 100 for communicating data. The network 100 comprises a base station 110 having a coverage area 101, a plurality of mobile devices 120, and a backhaul network 130. As shown, the base station 110 establishes uplink (dashed line) and/or downlink (dotted line) connections with the mobile devices 120, which serve to carry data from the mobile devices 120 to the base station 110 and vice-versa. Data carried over the uplink/downlink connections may include data communicated between the mobile devices 120, as well as data communicated to/from a remote-end (not shown) by way of the backhaul network 130. As used herein, the term “base station” refers to any component (or collection of components) configured to provide wireless access to a network, such as a gNB, a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with a base station, such as a user equipment (UE), a mobile station (STA), and other wirelessly enabled devices. In some embodiments, the network 100 may comprise various other wireless devices, such as relays, low power nodes, etc.

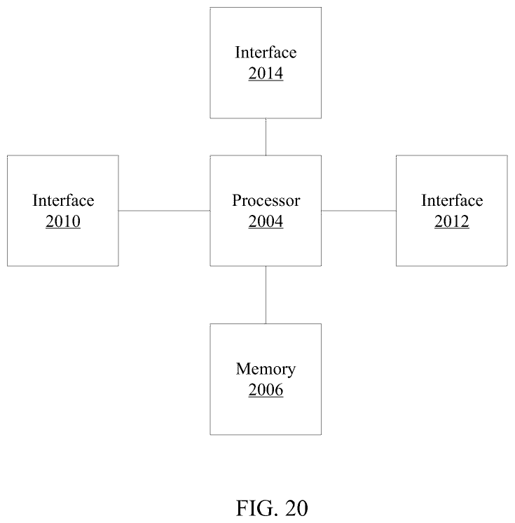

Embodiments of the present disclosure may be implemented as computer-implemented methods. The embodiments may be performed by a processing system. FIG. 20 illustrates a block diagram of an embodiment processing system 2000 for performing methods described herein, which may be installed in a host device. As shown, the processing system 2000 includes a processor 2004, a memory 2006, and interfaces 2010-2014, which may (or may not) be arranged as shown in FIG. 20. The processor 2004 may be any component or collection of components adapted to perform computations and/or other processing related tasks, and the memory 2006 may be any component or collection of components adapted to store programming and/or instructions for execution by the processor 2004. In an embodiment, the memory 2006 includes a non-transitory computer readable medium. The interfaces 2010, 2012, 2014 may be any component or collection of components that allow the processing system 2000 to communicate with other devices/components and/or a user. For example, one or more of the interfaces 2010, 2012, 2014 may be adapted to communicate data, control, or management messages from the processor 2004 to applications installed on the host device and/or a remote device. As another example, one or more of the interfaces 2010, 2012, 2014 may be adapted to allow a user or user device (e.g., personal computer (PC), etc.) to interact/communicate with the processing system 2000. The processing system 2000 may include additional components not depicted in FIG. 20, such as long term storage (e.g., non-volatile memory, etc.).

In some embodiments, the processing system 2000 is included in a network device that is accessing, or part otherwise of, a telecommunications network. In one example, the processing system 2000 is in a network-side device in a wireless or wireline telecommunications network, such as a base station, a relay station, a scheduler, a controller, a gateway, a router, an applications server, or any other device in the telecommunications network. In other embodiments, the processing system 2000 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

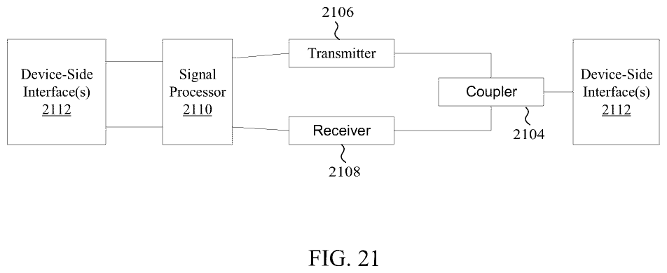

In some embodiments, one or more of the interfaces 2010, 2012, 2014 connects the processing system 2000 to a transceiver adapted to transmit and receive signaling over the telecommunications network. FIG. 21 illustrates a block diagram of a transceiver 2100 adapted to transmit and receive signaling over a telecommunications network. The transceiver 2100 may be installed in a host device. As shown, the transceiver 2100 comprises a network-side interface 2102, a coupler 2104, a transmitter 2106, a receiver 2108, a signal processor 2110, and a device-side interface 2112. The network-side interface 2102 may include any component or collection of components adapted to transmit or receive signaling over a wireless or wireline telecommunications network. The coupler 2104 may include any component or collection of components adapted to facilitate bi-directional communication over the network-side interface 2102. The transmitter 2106 may include any component or collection of components (e.g., up-converter, power amplifier, etc.) adapted to convert a baseband signal into a modulated carrier signal suitable for transmission over the network-side interface 2102. The receiver 2108 may include any component or collection of components (e.g., down-converter, low noise amplifier, etc.) adapted to convert a carrier signal received over the network-side interface 2102 into a baseband signal. The signal processor 2110 may include any component or collection of components adapted to convert a baseband signal into a data signal suitable for communication over the device-side interface(s) 2112, or vice-versa. The device-side interface(s) 2112 may include any component or collection of components adapted to communicate data-signals between the signal processor 2110 and components within the host device (e.g., the processing system 2000, local area network (LAN) ports, etc.).

The transceiver 2100 may transmit and receive signaling over any type of communications medium. In some embodiments, the transceiver 2100 transmits and receives signaling over a wireless medium. For example, the transceiver 2100 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 2102 comprises one or more antenna/radiating elements. For example, the network-side interface 2102 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 2100 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Additional details are provided below.

In RAN #94e the SID for “Study and improved NR positioning” was approved [RP-213588]. The first objective of the SI is to:
“Study solutions for sidelink positioning considering the following: [RAN1, RAN2]
   Scenario/requirements
      Coverage scenarios to cover: in-coverage, partial-coverage and out-of-coverage
      Requirements: Based on requirements identified in TR38.845 and TS22.261 and TS22.104
      Use cases: V2X (TR38.845), public safety (TR38.845), commercial (TS22.261), IIOT (TS22.104)
      Spectrum: ITS, licensed
   Identify specific target performance requirements to be considered for the evaluation based on existing 3GPP work and inputs from industry forums [RAN1]
   Define evaluation methodology with which to evaluate SL positioning for the use cases and coverage scenarios, reusing existing methodologies from sidelink communication and from positioning as much as possible [RAN1].
   Study and evaluate performance and feasibility of potential solutions for SL positioning, considering relative positioning, ranging and absolute positioning: [RAN1, RAN2]
      Evaluate bandwidth requirement needed to meet the identified accuracy requirements [RAN1]
      Study of positioning methods (e.g., TDOA, RTT, AOA/D, etc.) including combination of SL positioning measurements with other RAT dependent positioning measurements (e.g. Uu based measurements) [RAN1]
      Study of sidelink reference signals for positioning purposes from physical layer perspective, including signal design, resource allocation, measurements, associated procedures, etc., reusing existing reference signals, procedures, etc., from sidelink communication and from positioning as much as possible [RAN1]
      Study of positioning architecture and signaling procedures (e.g., configuration, measurement reporting, etc.) to enable sidelink positioning covering both UE based and network-based positioning [RAN2, including coordination and alignment with RAN3 and SA2 as required]

Note: When the bandwidth requirements have been determined and the study of sidelink communication in unlicensed spectrum has progressed, it can be reviewed whether unlicensed spectrum can be considered in further work. Checkpoint at RAN #97 to see if sufficient information is available for this review.”

The first objective of the SI SL positioning regarding of potential solutions for SL positioning, considering relative positioning, ranging and absolute positioning is examined. For this purpose, the design of the reference signals for positioning, including signal design, measurements, associated procedures with emphasize on reusing existing reference signals, procedures from sidelink communication and from positioning as much as possible is investigated.

### Factors That Influence Positioning Accuracy.

Signal Bandwidths and SNR: The channel bandwidth and the received SNR determines positioning accuracy for methods based on time-of-flight/arrival (TOF/TOA) distance measurements. From Cramer-Rao lower bound (CRLB) analysis, the variance of the TOA measurements for LOS channel is approximately lower bounded as:

$$var ( TOA ) \geq \frac{1}{8 {π}^{2} {β}^{2} SNR}$$

where β denotes the effective signal bandwidth.

$$β = \frac{{\int }_{- ∞}^{∞} {f}^{2} {\vert S ( f ) \vert}^{2} df}{{\int }_{- ∞}^{∞} {\vert S ( f ) \vert}^{2} df}$$

and SNR is the signal to noise ratio, f is the frequency and S(f) is the Fourier transform of the transmitted signal. The above inequality implies that higher signal bandwidth improves the TOA measurement accuracy. The investigation of the bandwidth impact on the location accuracy could indicate if the SL positioning solutions need to be extended or not to the unlicensed spectrum.

LOS vs. NLOS channel propagation.

If there is a direct path (LOS) between the anchor and the target nodes, a larger positioning signal bandwidth allows a better resolution of multipath components, which increases the accuracy of finding the first path and thus reducing the error caused by multipath biases for TOA, RTT and TDOA based methods. However, if such direct path (LOS) does not exist and the communication between the anchor and target nodes is done via reflections (non-LOS (NLOS)), the range between the anchor and the target nodes is overestimated due to the increased TOF.

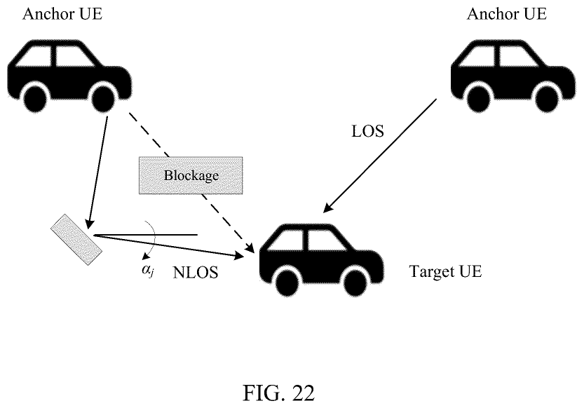

FIG. 22 is an illustration of an effect of an angle of arrival (AOA) and angle of departure (AOD) on non-line-of-sight (NLOS) propagation.

As depicted in FIG. 22, the angle of arrival (AOA) and angle of departures (AOD) estimations may be also affected by the NLOS propagation, which leads to low accuracy of the location estimates.

Time synchronization.

When a TOF, TOA based positioning method is used, the receiver may use the timestamp from the transmitter to estimate the TOF and thus the range between the transmitter and the receiver. However, even when the channel is LOS, if the clocks at the transmitter and receiver are not synchronized, additional errors are introduced, which affect the ranging and the position estimations. In TR38.855 the network synchronization error is defined as a truncated Gaussian distribution of (T1 nanoseconds (ns)) root mean square (rms) values between the anchor node and a timing reference source which is assumed to have perfect timing, subject to the largest timing difference of T2 ns, where T2=2*T1. That is, the range of timing errors is [−T2, T2]. Two values for T1 were proposed 0 ns (perfectly synchronized) and 50 ns.

Some positioning methods such as the multi-RTT are robust with respect to time synchronization provided that the clock drifts are negligible for the duration when the difference of the received time and transmit time of the positioning signals is measured, while others are more sensitive to the synchronization errors (such TOA). Therefore, when investigating SL positioning solutions, the synchronization errors between target and anchor nodes should be considered.

Proposal 1: The SL positioning study should investigate the BW size, non-ideal synchronization, and NLOS propagation impact on the SL positioning accuracy.

### Methods For Location Determinations.

The RAT-dependent methods for positioning as defined in Rel 16 and Rel 17 [TR38.855, TS 38.305] are based on reference signal (RS) exchanges between the anchor nodes (gNB) and target nodes (UE). In this contribution the target UE is the UE that requires position (location) determination, and the anchor nodes are those nodes (UE, gNB, RSU) that may be considered as reference for relative or absolute positioning of the target UE. The RAT dependent positioning methods were defined in Rel 16 and Rel 17 in addition to the RAT independent methods for positioning such as GNSS, Wi-Fi, Bluetooth, terrestrial beacon systems (TBS), and motion-based sensors. The RAT dependent methods are:
NR enhanced cell ID methods (NR E-CID) based on NR signals
Multi-Round Trip Time Positioning (Multi-RTT based on NR signals)
Downlink Angle-of-Departure (DL-AoD) based on NR signals
Downlink Time Difference of Arrival (DL-TDOA) based on NR signals
Uplink Time Difference of Arrival (UL-TDOA) based on NR signals;
Uplink Angle-of-Arrival (UL-AoA), including A-AoA and Z-AoA based on NR signals.
Hybrid positioning using multiple methods from the list of positioning methods above is also supported

The measurements to support the above methods are defined in TS 38.215.
Downlink PRS reference signal received power (DL PRS RSRP)
Downlink PRS reference signal received path power (DL PRS RSRPP)
Downlink PRS reference signal time difference (DL PRS RSTD)
UE Rx-Tx time difference

For sidelink positioning scenarios, at least one positioning reference signal is provided via sidelink (PC5), therefore a SL UE may be required to combine and measure sidelink PRS and DL PRS and transmit sidelink PRS and UL PRS.

For sidelink Mode 2 (expected in out of coverage scenarios) the reference nodes (anchor nodes) may be less reliable than for in coverage anchor nodes such as gNB. In these scenarios, it would be preferable to use positioning methods, such multi-RTT, which are more robust with respect to clock synchronization between anchor and target nodes.

Observation 1: For sidelink Mode 2 operation, robust positioning methods, such multi-RTT, are preferable.

Proposal 2: RAN1 should discuss the SL UE support of the positioning methods and measurements defined in Rel-16, and Rel 17.

Proposal 3: For position determination SL UE should support the aggregation of DL PRS resources with SL positioning resources.

One basic requirement for positioning in 5G services is the support of positioning in OOC scenarios when all the devices involved in the SL positioning are out of reach of LMF.

The OOC scenario positioning is part of the SID and required by 5G specifications as in TS 22.104.

“The 5G system shall provide positioning information for a UE that is out of coverage of the network, with accuracy of <[1 m] relative to other UEs that are in proximity and in coverage of the network.”

The TS 22.261 requirement on positioning allows data to be available at the UE, which makes possible UE based positioning and positioning in OOC scenarios.

“The 5G system shall be able to make the position-related data available to an application or to an application server existing within the 5G network, external to the 5G network, or in the User Equipment.”

In the OOC case, it is not clear whether a similar entity to LMF is still necessary and if so where should be located. It seems rather obvious that the target UE should support a function that allows it to compute an estimation of the location. Such functionality and complexity may depend on the OOC covered scenarios such ranging, relative positioning or absolute positioning.

The SL positioning solutions for OOC scenarios should be able to select the positioning method, to configure and enable the sidelink reference signal transmissions per request or triggered by an event, to select the anchor nodes and enable RRC connectivity if necessary, to obtain the location information or to request S-PRS transmissions, to provide or exchange the location information if requested, to configure and enable the collection of SL positioning measurements to estimate the relative or the absolute position.

Some of the positioning methods involve an exchange between the target node and anchor nodes. For instance, in a UE based positioning multi-RTT the anchor nodes should provide the SL UE target node the measurements of Rx-Tx, which will be combined with the Rx-Tx measurements at the target node to obtain the final position estimation. Another example of data exchange between target node and anchor nodes may be the absolute position coordinates provided by the anchor nodes to the target node. Such exchange may be carried out only after a RRC connection is established between the target and anchor nodes that could enable data encryption and therefore privacy.

Proposal 4: The SL positioning solutions should support the necessary configurations and controls for OOC SL positioning.

These requirements for the OOC SL positioning solutions may be achieved by two possible approaches. One option is to start from scratch and define new protocols and new signaling that would support the necessary SL positioning methods.

Another option is to build on the existing SL design and to extend the existing protocols with the necessary signaling that implements the SL positioning methods. The Inter UE Coordination (IUC) feature, defined in Rel 17, is a good candidate that may be considered and extended to support the SL positioning solutions for the OOC scenarios. The IUC offers the necessary framework to request and respond for the measurements and location information, to configure and trigger the necessary signaling, and to coordinate the transmissions of the anchor nodes. In addition, reusing the IUC would minimize the specifications impact.

Proposal 5: Consider reusing or extending the IUC framework defined in Rel 17 for OOC SL positioning solutions.

### 4. Rel17 Positioning Reference Signals.

The RAT-dependent methods for positioning as defined in Rel 16 and Rel 17 [TR38.855, TR 38.305] are based on reference signal (RS) exchanges between the anchor nodes (gNB) and target UE. More precisely, the gNB transmits a DL positioning RS (DL PRS) signal. The UE transmits an UL sounding reference signal (UL PRS) based on a configuration provided by SRS-PosResourceSet, which differs from the SRS used for UL channel estimation based on a configuration given by SRS-ResourceSet.

### 4.1 DL PRS.

DL PRS signal as defined in TS38.211 is a length-31 Gold QPSK sequence, where the pseudo-random sequence generator is initialized based the slot number, the DL PRS sequence ID, n_{ID,seq}^{PRS}∈{0,1, . . . ,4095} and the OFDM symbol index in the slot to which the sequence is mapped. The PRS sequence ID allows frequency reuse, while the slot and symbol indices allow the TOF, TOA, TDOA and RTT determination.

In time domain, the size of the DL PRS resources is L_{PRS}∈{2,4,6,12} symbols and it is given by the higher-layer parameter dl-PRS-NumSymbols.

In frequency domain a PRS resource has a comb distribution (i.e., resource element (RE) spacing in each symbol of DL-PRS Resource) where the comb size K_{comb}^{PRS}∈{2, 4, 6,12} is given by the higher-layer parameter dl-PRS-CombSizeN-AndReOffset for a downlink PRS resource configured for RTT-based propagation delay compensation, otherwise by the higher-layer parameter dl-PRS-CombSizeN such that the combination {L_{PRS}, K_{comb}^{PRS}) is one of {2, 2}, {4, 2}, {6, 2}, {12, 2}, {4, 4}, {12, 4}, {6, 6}, {12, 6} and {12, 12}.

The comb distribution allows a wider bandwidth of the RS signal, and therefore as better accuracy for TOA estimation. However, the gaps in frequency generate aliases in time, which may be compensated by the repetition of PRS in time and coherent combining. For instance, if two symbols with comb-4 are coherently combine the result is equivalent with a comb-2 PRS signal.

The frequency offset from symbol to symbol is selected such that there is no staircase pattern. This has the main advantage that increases the robustness (for instance against Doppler shifts) when using just the first symbols for a coherent combining. In addition, the comb design and the offset in frequency between the consecutive symbols offers an increases robustness to the wideband fading, and orthogonality with respect to other PRS signals from other transmission/reception points (TRPs).

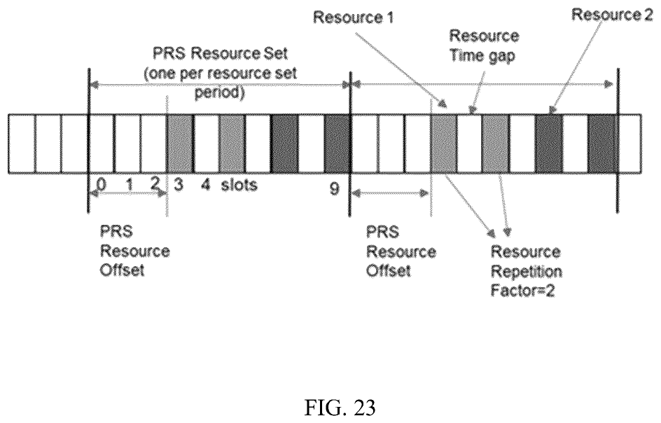

A PRS resource is defined by ID, sequence ID {0, . . . ,4095}, the comb size {2,4,6,12} and the RE offsets for the remaining symbols, resource slot offset (FIG. 23), resource symbol offset, and quasi-colocation (QCL) information.

A DL PRS resource set is configured by NR-DL-PRS-ResourceSet, consists of one or more DL PRS resources, where each resource has an associated spatial transmission filter (transmission direction).

The PRS resource set [TS 38.214] is characterized by ID, subcarrier spacing, periodicity (of the resource set transmissions), resource list, resource repetition factor (number of repetitions of each resource during an instance of the resource set), resource time gap (a number of slots between resource consecutive repetitions), comb size, resource bandwidth (between 24 PRBs and 272 PRBs in 4 PRBs increment), the start of PRB index, and the number of resource symbols in the PRS slot. The PRS resource set can be located anywhere in the frequency grid via the start of PRB index, which is an offset with respect to the reference frequency Point A.

A PRS resource set is sent by gNB with a periodicity, Tₚₑᵣ^{PRS}∈2^{μ}{4, 5, 8, 10, 16, 20, 32, 40, 64, 80, 160, 320, 640, 1280, 2560, 5120, 10240} slots.

The PRS resource repetition factor defines how many times each DL-PRS resource is repeated for a single instance of the DL-PRS resource set and may take values Tᵣₑₚ^{PRS}∈{1,2,4,6,8,16,32}. All the DL PRS resources within one resource set have the same resource repetition factor.

To mitigate interference on weak PRS signals, the strong PRS signals may be muted. The muting pattern is specified by a bit string of {2,4,8,16,32} bits in each cell, where a bit indicates if the PRS transmission in the corresponding slot is muted or not.

A UE in RRC connected state is required to measure the DL PRS only in the active bandwidth part (BWP) and with the same numerology as the active BWP. UE may request the serving gNB measurement gaps that can be used to measure DL PRS outside the active BWP and with different numerology.

For 15 kHz SCS the minimum DL PRS is about 5 MHz and the maximum about 50 MHz. With a 120 kHz SCS the DL PRS minimum bandwidth is about 34 mega Hertz (MHz), and the maximum bandwidth is about 400 MHz.

### 4.2 UL PRS.

The UL positioning RS (UL PRS) is based on the sounding RS (SRS) and referred as SRS for positioning. The UL PRS sequence is 31 bit Zadoff-Chu, which offers good peak to average ratio. The UL PRS may span in time for {1,2,4,8.12} consecutive OFDM symbols, which can be located anywhere in the slot. Similar with DL PRS, the UL PRS has a comb-N pattern in frequency, with comb size {2.4,8}. Like UL PRS, the DL PRS has a comb offset which defines the relative frequency shifts between consecutive OFDM symbols. The offset offers similar advantage as for DL PRS, i.e., only first few symbols may be considered for TOA measurement through a coherent combining. Like DL PRS, the UL PRS may be transmitted periodically with certain periodicity and slot offset. However, the semi-persistent configuration is activated and deactivated via MAC-CE signaling. An aperiodic UL PRS is transmitted only when UE is instructed by gNB via Downlink Control Information (DCI). UL PRS supports spatial relationships, where the spatial relation can be either a DL reference signal (SSB, CSI-RS or DL-PRS) or by the previously transmitted SRS or UL-PRS. The UL PRS can also have a spatial relationship with a neighbor TRP.

Another property of the UL PRS is the power transmit control, where UE estimates the UL pathloss for serving and neighbor TRPs based on DL measurements and sets the UL PRS power accordingly.

The UL PRS resource set comprises of one or multiple UL PRS resources, and is defined by resource set ID, resource type (aperiodic, semi-persistent, periodic), alpha the value that characterizes the fractional power control, p0 the desired receive power at TRP, pathloss reference RS and the UL PRS resource list.

The UL resource is described by an ID, transmission comb, resource mapping (symbol location in UL PRS slot), frequency domain shift, bandwidth indication (as part of the Frequency Hopping, which is not used for frequency hopping indication as for SRS case), resource type (periodic, semi-persistent, aperiodic), and the corresponding periodicity, sequence ID used to initialize the pseudo-random group and sequence hopping and a spatial relation information.

Like for DL PRS, the UE may be configured with multiple UL PRS resource sets.

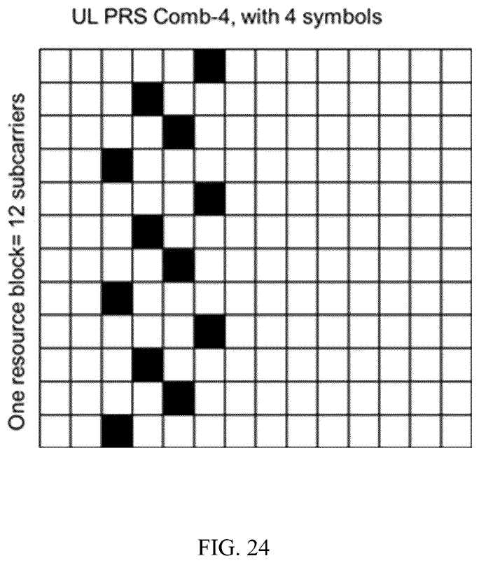

FIG. 24 is an illustration of a UL PRS resource configuration.

### 5. Reference Signals For Sidelink Positioning.

### 5.1. S-SSB

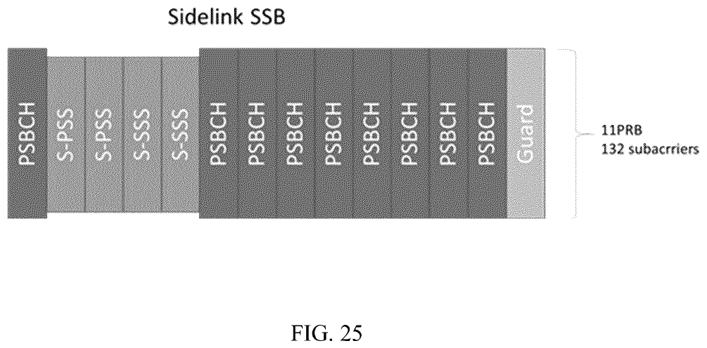

FIG. 25 is an illustration of a S-SSB. Sidelink Synchronization Signal Block (S-SSB) is a broadcast signal defined in TS 38.211, which is used for the synchronization purposes, and it is composed of the Sidelink Primary Synchronization Signal (S-PSS), Sidelink Secondary Synchronization Signal (S-SSS), and Physical Sidelink Broadcast Channel (PSBCH). There are 672 unique physical layer sidelink synchronization identities, and they are divided in two sets {0,1, . . . , 335} and {336, . . . ,671}. The Sidelink Synchronization Signal ID (SLSSID) indicates the source of time reference (GNSS, gNB or another SL UE (SyncRef UE)), and therefore give an information of the accuracy of the time reference. Prior to start sending S-SSB a SL UE must select its own time reference and advertise it via SLSSID.

In the frequency domain S-SSB occupies 11 Physical Resource Blocks (PRBs), i.e., 132 subcarriers, where S-PSS and S-SSS each occupy 127 subcarriers and are repeated twice during the S-SSB slot. The PSBCH occupies 132 subcarriers for the duration of eight symbols (FIG. 5). The first PSBCH symbol serves for automatic gain control (AGC) purpose. Each S-SSB transmission is repeated several times during each period of 16 subframes. The frequency location of S-SSB is fixed.

The S-SSB may be used primarily by a receiver SL UE to acquire synchronization with the transmitter SL device, or for the target SL UE to measure Time Difference of Arrival (TDOA) between two SyncRef UE that are synchronized with the same reference time. Thus, the target SL UE could estimate relative position to SyncRef UE.

Observation 2: The S-SSB could be adapted to estimate the TDOA between anchor SL devices.

Observation 3: The accuracy of TDOA estimate is increased when the S-SSB originators have the same reference time (SLSSID).

Observation 4: The usage of S-SSB for positioning may enable SL UE positioning in RRC_INACTIVE state.

Proposal 6: Consider supporting the S-SSB based SL position determination.

### 5.2. Sidelink Positioning Signal (S-PRS).

One of the topics of this SI is:
Study of sidelink reference signals for positioning purposes from physical layer perspective, including signal design, resource allocation, measurements, associated procedures, etc., reusing existing reference signals, procedures, etc., from sidelink communication and from positioning as much as possible [RAN1]

In out-of-coverage (OOC) scenarios, the target SL UE must rely on the sidelink (PC5) reference signals received from other SL devices (SL UE, RSU) to determine the range, or position. As noted above, the signal bandwidth plays a crucial role in estimation accuracy. The bandwidth of S-SSB may not be sufficient, moreover the S-SSB periodicity (160 ms) may be add additional latency to position determination. Thus, it is necessary that RAN1 defines a SL positioning reference signal (S-PRS) that shares some of the common features of DL and UL PRS such as
Flexible bandwidth size
Comb-N distribution in frequency
Repetition with frequency offset in consecutive symbols
Different length in time, and periodicity of the resource set
Aperiodic, semi-static and periodic transmissions

The Zadoff-Chu (ZC) sequence used for uplink PRS offers better PAPR properties (small power variations in time and frequency) with respect to Gold Sequence used for DL PRS. In our view, such peak-to-average power ratio (PAPR) properties are desirable for SL UE to avoid nonlinear signal distortions.

Proposal 7: RAN1 should consider the UL PRS design as the starting point of the S-PRS design.

A SL UE at the fringe of the network coverage may be required to participate in SL positioning exchange with other SL in partial coverage. Thus, the serving gNB should be able to control and configure the S-PRS UE transmissions in its coverage to minimize interference and maximize capacity.

Proposal 8: Consider whether the S-PRS configuration should be controlled by gNB when SL UEs are in coverage or partial coverage.

### 6. SL Positioning Architecture.

TS 38.305 defines functional specifications of UE positioning in NG-RAN. The document defines the positioning methods, positioning architecture and signaling protocols and interfaces. Rel 16 and Rel 17 positioning solutions rely on LTE Positioning Protocol (LPP) and Location Management Function (LMF). Particularly LMF is vital for the orchestration of the positioning methods and protocols.

“For positioning of a target UE, the LMF decides on the position methods to be used, based on factors that may include the LCS Client type, the required QoS. UE positioning capabilities, gNB positioning capabilities and ng-eNB positioning capabilities. The LMF then invokes these positioning methods in the UE, serving gNB and/or serving ng eNB. The positioning methods may yield a location estimate for UE-based position methods and/or positioning measurements for UE-assisted and network-based position methods. The LMF may combine all the received results and determine a single location estimate for the target UE (hybrid positioning).”

When SL UE that participate in positioning exchange are in coverage of gNB, the existing positioning protocol (LTE Positioning Protocol) should be still supported. The LMF through Uu connections and SL relaying should be able to coordinate and process the measurements for positioning.

At the same time, gNB may forward the measurements from SL UE to LMF to estimate position of SL UE in partial coverage.

Proposal 9: In this study RAN1 should consider as working assumption that LMF is extended to support SL positioning for SL UE in coverage or partial coverage.

Proposal 10: RAN1 should send a LS to RAN2 and RAN3 to ask extending the existing LMF protocol for SL UEs in coverage or partial coverage.

### 7. Conclusions.

Proposal 1: The SL positioning study should investigate the BW size, non-ideal synchronization, and NLOS propagation impact on the SL positioning accuracy.

Observation 1: For sidelink Mode 2 operation, robust positioning methods, such multi-RTT, are preferable.

Proposal 2: RAN1 should discuss the SL UE support of the positioning methods and measurements defined in Rel-16, and Rel 17.

Proposal 3: For position determination SL UE should support the aggregation of DL PRS resources with SL positioning resources.

Proposal 4: The SL positioning solutions should support the necessary configurations and controls for OOC SL positioning.

Proposal 5: Consider reusing or extending the IUC framework defined in Rel 17 for OOC SL positioning solutions.

Observation 2: The S-SSB could be adapted to estimate the TDOA between anchor SL devices.

Observation 3: The accuracy of TDOA estimate is increased when the S-SSB originators have the same reference time (SLSSID).

Observation 4: The usage of S-SSB for positioning may enable SL UE positioning in RRC_INACTIVE state.

Proposal 6: Consider supporting the S-SSB based SL position determination.

Proposal 7: RAN1 should consider the UL PRS design as the starting point of the S-PRS design.

Proposal 8: Consider whether the S-PRS configuration should be controlled by gNB when SL UEs are in coverage or partial coverage.

Proposal 9: In this study RAN1 should consider as working assumption that LMF is extended to support SL positioning for SL UE in coverage or partial coverage.

Proposal 10: RAN1 should send a LS to RAN2 and RAN3 to ask extending the existing LMF protocol for SL UEs in coverage or partial coverage.

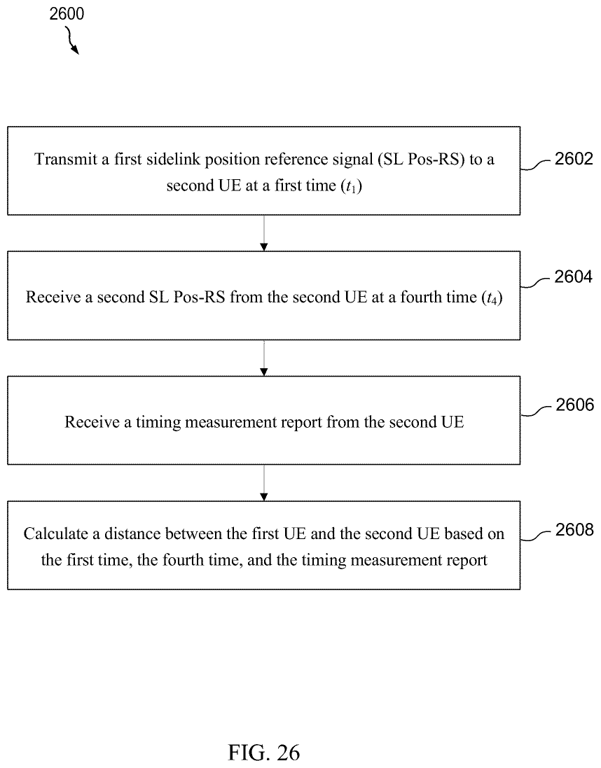

FIG. 26 is a method implemented by a first UE according to an embodiment of the present disclosure. In block 2602, the first UE transmits a first sidelink position reference signal (SL Pos-RS) to a second UE at a first time (t₁). In block 2604, the first UE receives a second SL Pos-RS from the second UE at a fourth time (t₄). In block 2606, the first UE receives a timing measurement report from the second UE, wherein the timing measurement report contains information regarding a second time (t₂) when the first SL Pos-RS was received by the second UE and regarding a third time (t₃) when the second UE transmitted the second SL Pos-RS to the first UE. In block 2608, the first UE calculates a distance between the first UE and the second UE based on the first time, the fourth time, and the timing measurement report.

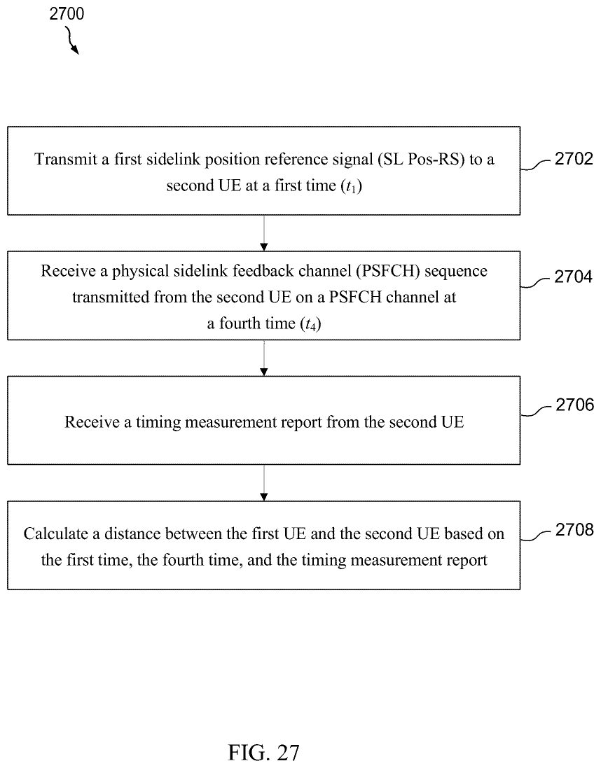

FIG. 27 is a method implemented by a first UE according to an embodiment of the present disclosure. In block 2702, the first UE transmits a first sidelink position reference signal (SL Pos-RS) to a second UE at a first time (t₁). In block 2704, the first UE receives a physical sidelink feedback channel (PSFCH) sequence transmitted from the second UE on a PSFCH channel at a fourth time (t₄). In block 2706, the first UE receives a timing measurement report from the second UE, wherein the timing measurement report contains information regarding a difference between a second time (t₂) when the first SL Pos-RS was received by the second UE and regarding a third time (t₃) when the second UE transmitted the second SL Pos-RS to the first UE. In block 2708, the first UE calculates a distance between the first UE and the second UE based on the first time, the fourth time, and the timing measurement report.

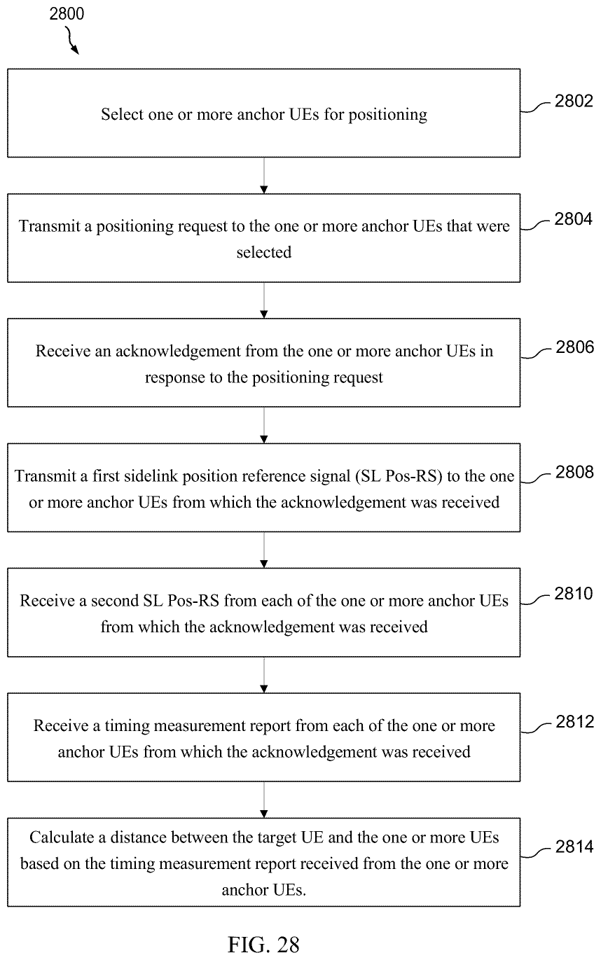

FIG. 28 is a method implemented by a target UE according to an embodiment of the present disclosure. In block 2802, the target UE selects one or more anchor UEs for positioning. In block 2804, the target UE transmits a positioning request to the one or more anchor UEs that were selected. In block 2806, the target UE receives an acknowledgement from the one or more anchor UEs in response to the positioning request. In block 2808, the target UE transmits a first sidelink position reference signal (SL Pos-RS) to the one or more anchor UEs from which the acknowledgement was received. In block 2810, the target UE receives a second SL Pos-RS from each of the one or more anchor UEs from which the acknowledgement was received. In block 2812. the target UE receives a timing measurement report from each of the one or more anchor UEs from which the acknowledgement was received. In block 2814, the target UE calculates a distance between the target UE and the one or more UEs based on the timing measurement report received from the one or more anchor UEs.

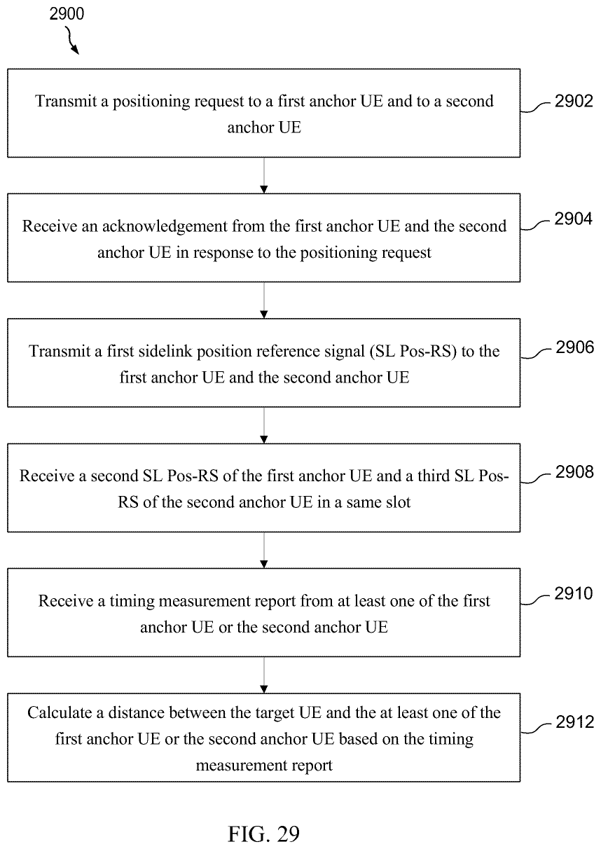

FIG. 29 is a method implemented by a target UE according to an embodiment of the present disclosure. In block 2902, the target UE transmit a positioning request to a first anchor UE and to a second anchor UE. In block 2904, the target UE receives an acknowledgement from the first anchor UE and the second anchor UE in response to the positioning request. In block 2906, the target UE transmit a first sidelink position reference signal (SL Pos-RS) of the target UE to the first anchor UE and the second anchor UE. In block 2908, the target UE receives a second SL Pos-RS of the first anchor UE and a third SL Pos-RS of the second anchor UE in a same slot. In block 2910, the target UE receives one or more timing measurement reports from the first anchor UE and/or the second anchor UE. In block 2912, the target UE calculates a distance between the target UE and at least one of the first anchor UE or the second anchor UE based on the timing measurement report received.

The following references may provide additional details:
[1] RP-213588, Study on expanded and improved NR positioning, RAN #94e, December 2021.
[2] TR 38.845, Study on scenarios and requirements of in-coverage, partial coverage, and out-of-coverage NR positioning use cases (Release 17)
[3] TS 22.261 Service requirements for the 5G system
[4] TS 22.186 Enhancement of 3GPP support for V2X scenarios: Stage 1 (Release 17)
[5] TS 22.104 Service requirements for cyber-physical control applications in vertical domains: Stage I (Release 18)
[6] 5GAA, A-200134, “Draft reply to LS to 3GPP RAN on requirements of in-coverage, partial coverage, and out-of-coverage positioning use cases” [7]
[7] TS 38.855, Study on NR positioning support (Release 16)
[8] TS 38.211, Physical channels and modulation (Release 17)

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a first user equipment (UE), comprising:
transmitting a first sidelink position reference signal (SL Pos-RS) to a second UE at a first time (t₁);
receiving a physical sidelink feedback channel (PSFCH) sequence transmitted from the second UE on a PSFCH channel at a fourth time (t₄);
receiving a timing measurement report from the second UE, wherein the timing measurement report includes information regarding a difference between a second time (t₂) when the first SL Pos-RS was received by the second UE and regarding a third time (t₃) when the second UE transmitted a second SL Pos-RS to the first UE; and
calculating a distance between the first UE and the second UE based on the first time, the fourth time, and the timing measurement report.

2. The method of claim 1, wherein the PSFCH sequence includes a plurality of PSFCHs in a single physical resource block (PRB) set.

3. The method of claim 1, wherein a hybrid automatic repeat request acknowledgement (HARQ-ACK) is excluded from a single physical resource block (PRB) set.

4. The method of claim 1, wherein a hybrid automatic repeat request acknowledgement (HARQ-ACK) is included in a single physical resource block (PRB) set and used for calculating the distance.

5. The method of claim 4, wherein a cyclic shift is applied to the HARQ-ACK to shift the HARQ-ACK from the PSFCH channel to a different PSFCH channel.

6. The method of claim 1, wherein physical resource block (PRB) sets not configured for a hybrid automatic repeat request acknowledgement (HARQ-ACK) are used in the PSFCH sequence.

7. A method implemented by a first user equipment (UE), comprising:
transmitting a first sidelink position reference signal (SL Pos-RS) to a second UE at a first time (t₁);
receiving a second SL Pos-RS from the second UE at a fourth time (t₄);
receiving a timing measurement report from the second UE, wherein the timing measurement report contains information regarding a second time (t₂) when the first SL Pos-RS was received by the second UE and regarding a third time (t₃) when the second UE transmitted the second SL Pos-RS to the first UE; and
calculating a distance between the first UE and the second UE based on the first time, the fourth time, and the timing measurement report.

8. The method of claim 7, wherein the distance is calculated using the following formula:
$${D}_{1 , 2} = c \cdot \frac{( {t}_{4} - {t}_{1} ) - ( {t}_{3} - {t}_{2} )}{2} ,$$
where D_{1,2} represents the distance and where c represents a speed of light.

9. The method of claim 7, wherein the first UE comprises a target UE, the second UE comprises an anchor UE, and wherein the timing measurement report includes a time value that represents a difference between the third time and the second time.

10. The method of claim 7, wherein the first UE transmits one or more first SL Pos-RS in accordance with a first semi-persistent configuration, where the first semi-persistent configuration comprises a period, a number of first SL Pos-RS transmissions, and parameters to generate the one or more first SL Pos-RS; and
wherein the first UE receives one or more second SL Pos-RS in accordance to a second semi-persistent configuration, where the second semi-persistent configuration comprises a period, a number of second SL Pos-RS transmissions, and parameters to generate the one or more second SL Pos-RS.

11. The method of claim 7, wherein the timing measurement report includes a value for each of the second time and the third time.

12. The method of claim 7, wherein the timing measurement report includes a value representing a difference between the second time and the third time, and wherein the difference represents fractions of a subframe or slot.

13. The method of claim 7, wherein the first time, the second time, the third time, and the fourth time each correspond to a reference orthogonal frequency-division multiplexing (OFDM) symbol.

14. The method of claim 7, wherein the timing measurement report includes a number of orthogonal frequency-division multiplexing (OFDM) symbols and a relative timing offset corresponding to the second time and the third time.

15. The method of claim 7, wherein a difference between the second time and the third time is included in the second SL Pos-RS.

16. A method implemented by a target user equipment (UE), comprising:
selecting one or more first anchor UEs for positioning;
transmitting a positioning request to the one or more first anchor UEs;
receiving an acknowledgement from one or more second anchor UEs in response to the positioning request, the one or more second anchor UEs being at least part of the one or more first anchor UEs;
transmitting a first sidelink position reference signal (SL Pos-RS) to the one or more second anchor UEs;
receiving a timing measurement report from each of the one or more second anchor UEs; and
calculating a distance between the target UE and the one or more first anchor UEs based on the timing measurement report received from each of the one or more second anchor UEs.

17. The method of claim 16, further comprising discovering one or more available candidate anchor UEs and selecting the one or more first anchor UEs from the one or more available candidate anchor UEs.

18. The method of claim 16, wherein the one or more first anchor UEs are selected for positioning based on one or more of a source of synchronization, a received signal strength, an anchor feature, a location zone, or a mobility of the one or more anchor UEs.

19. The method of claim 16, further comprising receiving a second SL Pos-RS from the one or more second anchor UEs before transmitting the first SL Pos-RS to the one or more second anchor UEs.

20. The method of claim 16, further comprising receiving a second SL Pos-RS from the one or more second anchor UEs, wherein the timing measurement report is encoded in the second SL Pos-RS or multiplexed with the second SL Pos-RS.

21. A method implemented by a target user equipment (UE), comprising:
transmitting a positioning request to a first anchor UE and to a second anchor UE;
receiving an acknowledgement from the first anchor UE and the second anchor UE in response to the positioning request;
transmitting a first sidelink position reference signal (SL Pos-RS) of the target UE to the first anchor UE and the second anchor UE;
receiving a second SL Pos-RS of the first anchor UE and a third SL Pos-RS of the second anchor UE in a slot;
receiving a timing measurement report from at least one of the first anchor UE or the second anchor UE; and
calculating a distance between the target UE and the at least one of the first anchor UE or the second anchor UE based on the timing measurement report.

22. The method of claim 21, wherein the second SL Pos-RS is received in a first part of the slot and the third SL Pos-RS is received in a second part of the slot, and wherein the first part of the slot is a first set of symbols and the second part of the slot is a second set of symbols separated in time.

23. The method of claim 21, wherein the second SL Pos-RS is separated from the third SL Pos-RS by one or more guard symbols.

24. The method of claim 21, wherein a number of orthogonal frequency-division multiplexing (OFDM) symbols for each of the second SL Pos-RS and the third SL Pos-RS is four.

25. The method of claim 21, wherein the timing measurement report is based on a measured receiver-transmitter (Rx-Tx) time difference, or are based on a Release-16 or Release-17 definition for gnodeB (gNB) Rx-Tx time difference measurement or UE Rx-Tx time difference in Uu.

26. The method of claim 21, wherein transmissions of comb-based SL Pos-RS are multiplexed from one or more UEs in a slot in a sidelink resource pool.

27. The method of claim 26, wherein a configuration of a SL Pos-RS comprises a single (M, N) value for comb-based multiplexing in a slot of two or more SL Pos-RS from two or more UEs, and wherein M is a number of orthogonal frequency-division multiplexing (OFDM) symbols in the slot scheduled for the SL Pos-RS and N is a comb size.

28. The method of claim 27, wherein the comb size comprises 2 and 4.

29. The method of claim 21, wherein the timing measurement report comprises a measurement including a line-of-sight (LOS) path or all non-line-of-sight (NLOS) paths.

30. The method of claim 21, wherein a configuration of a side link positioning reference signal (SL PRS) comprises an:
SL PRS resource identifier (ID),
SL PRS comb offset and associated SL-PRS comb size (N),
SL PRS starting symbol and number of SL-PRS symbols (M), and
SL PRS frequency domain allocation.
